(19) United States
(12) Patent Application Publication
(10) Pub. No.: US 2009/0244223 A1
(43) Pub. Date: Oct. 1, 2009

(54) LIQUID CONTAINER AND MEMBRANE VALVE

(76) Inventors: Tadahiro Mizutani, Shiojiri-shi (JP); Hiroyuki Kawate, Shiojiri-shi (JP); Taku Ishizawa, Shiojiri-shi (JP); Shun Oya, Shiojiri-shi (JP)

Correspondence Address: STROOCK & STROOCK & LAVAN LLP, 180 MAIDEN LANE, NEW YORK, NY, 10038, US

(21) Appl. No.: 12/407,026

(22) Filed: Mar. 19, 2009

(30) Foreign Application Priority Data
Mar. 21, 2008 (JP) 2008-73272

(51) Int. Cl. B41J 2/175; F16K 7/00

(52) U.S. Cl. 347/86; 251/331

(57) ABSTRACT

A membrane valve having a membrane portion is used. The membrane valve can be formed using an elastomer. Also, the membrane valve can include N (N is an integer of 2 or greater) engaging portions that engage with the membrane support portion. Also, the membrane portion can also be affixed at a position closer to the first seal surface than the second seal surface in the seal portion. Here, the contact area of the first seal surface and the first member can be larger than the contact surface of the second seal surface and the second member. Also, in a first case where the end of the projecting portion is faced to a first plane and the membrane valve placed on the first plane, the end of the first support portion contacts the first plane and supports the membrane valve, and the end of the projecting portion can contact the first plane in a state with the membrane portion not deformed. Also, the projecting portion inserted inside the end of the coil spring can be arranged at the center axis side separated from the range of the position in which the projecting portion can contact the end of the coil spring by motion of the coil spring within the concave portion in the direction perpendicular to the center axis of the coil spring.

### CROSS-REFERENCE TO RELATED APPLICATIONS

The present application claims the priority based on Japanese Patent Application No. 2008-73272 filed on Mar. 21, 2008, the disclosure of which is hereby incorporated by reference in its entirety.

### BACKGROUND

1. Technical Field

The present invention relates to a liquid container and a membrane valve, and particularly to a liquid container that can be installed in a liquid jetting device and a membrane valve used for this liquid container.

2. Description of the Related Art

With an ink tank that supplies ink to an inkjet printer, technology is known that keeps the stored ink at negative pressure. For example, as means for generating negative pressure, an ink tank having a valve constitution using a membrane valve and a spring is known.

Also, various technologies that use valves are known relating to ink tanks that supply ink to inkjet printers. For example, valves for introducing the atmosphere to an ink tank are known.

### SUMMARY

However, there is also the possibility of various problems relating to valves. Examples of problems include the possibility of the negative pressure generated by the valve becoming unstable, and the possibility of the valve opening and closing becoming unstable, and the differential pressure control becoming unstable. These kinds of problems are not limited to the ink tank of an inkjet printer, but are also problems common to liquid containers that can be installed on a liquid jetting device.

The advantage of a number of modes of the invention is the provision of technology that decreases the possibility of problems relating to valves with liquid containers installed in a liquid jetting device.

The present invention can be reduced as the following aspects and modes for addressing at least part of the problems described above.

Mode A. A liquid container that can be installed in a liquid jetting device, equipped with a main body having a liquid storage chamber for storing liquid, a liquid supply port for supplying the liquid to the liquid jetting device, a first flow path linked to the liquid storage chamber, a second flow path linked to the liquid supply port, and equipped with a membrane valve having a membrane portion interposed between the first flow path and the second flow path, the membrane valve having a first surface and a second surface on the side facing opposite the first surface, the first surface receiving a first fluid pressure of the liquid in the first flow path, the second surface receiving a second fluid pressure of the liquid in the second flow path, the membrane portion of the membrane valve deforming to an open valve state that links the first flow path and the second flow path when the difference of the first fluid pressure in relation to the second fluid pressure (differential pressure) exceeds a specified pressure, and deforming to a closed valve state so that the first flow path and the second flow path are not linked when the difference (differential pressure) is the specified pressure or less, and the membrane valve is formed using an elastomer.

By working in this way, the membrane valve is formed using an elastomer, so the deformation of the membrane portion of the membrane valve in relation to the pressure is stabilized, and the negative pressure generated by the membrane valve is stabilized.

Mode B. A membrane valve supported on a membrane support portion and interposed between a first flow path and a second flow path, with the first flow path and the second flow path linked in the open state, and used as a valve that blocks the link between the first flow path and the second flow path in the closed state, comprising a valve main portion and an attachment portion fixed to the valve main portion, the valve main portion including a membrane portion that deforms according to the difference between a first pressure of the first flow path and a second pressure of the second flow path (differential pressure), and a movable portion that opens and closes the valve by moving according to the deformation of the membrane portion, and the attachment portion includes N (N is an integer of 2 or greater) engaging portions that engage with the membrane support portion.

With this constitution, the position of the membrane valve is determined by the N (N is an integer of 2 or greater) engaging portions, so it is possible to reduce the possibility of movable seal position skew.

Mode C. A membrane valve interposed between a first flow path and a second flow path, with the first flow path and the second flow path linked in the open state, and used as a valve that blocks the link between the first flow path and the second flow path in the closed state, comprising a membrane portion that deforms according to the difference between a first pressure of the first flow path and a second pressure of the second flow path (differential pressure), and a seal portion that is fixed to the membrane portion and is thicker than the membrane portion, the membrane valve being a membrane valve used in a first state with the seal portion sandwiched by a first member and a second member, the seal portion including a first seal surface that contacts the first member in the first state, and a second seal surface that contacts the second member in the first state, the contact area of the first seal surface and the first member being larger than the contact area of the second seal surface and the second member, and the membrane portion being fixed at a position closer to the first seal surface than the second seal surface between a plane including the first seal surface and a plane including the second seal surface.

With this constitution, when the seal portion is deformed, it is possible to reduce the possibility of the membrane portion deforming to an unintentional shape.

Mode D. A membrane valve interposed between a first flow path and a second flow path, with the first flow path and the second flow path linked in the open state, and used as a valve that blocks the link between the first flow path and the second flow path in the closed state, comprising a membrane portion that deforms according to the difference between a first pressure of the first flow path and a second pressure of the second flow path (differential pressure), a projecting portion affixed to the membrane portion that moves according to the deformation of the membrane portion, and a first support portion, and in a first case with the end of the projecting portion facing a first plane which is a horizontal surface and the membrane valve being placed from vertically upward onto the first plane, the end of the first support portion contacts the first plane and supports the membrane valve, and in a state with the membrane portion not deformed, the end of the projecting portion contacts the first plane.

With this constitution, it is possible to reduce the possibility of deformation of the membrane portion when the membrane valve is placed on a plane.

Mode E. A membrane valve arranged at a specified position facing opposite a concave portion, urged by the other end of a coil spring for which one end is received in the concave portion, being a membrane valve interposed between a first flow path and a second flow path, with the first flow path and the second flow path linked in the open state, and used as a valve that blocks the link between the first flow path and the second flow path in the closed state, comprising a membrane portion that deforms according to the difference between a first pressure of the first flow path and a second pressure of the second flow path (differential pressure), and a projecting portion inserted in the inside of the other end of the coil spring, the projecting portion arranged at the center axis side separated from the range of the position at which the other end of the coil spring can be contacted by the coil spring moving in the direction perpendicular to the coil spring center axis within the concave portion.

With this constitution, when the coil spring is moved within the concave portion, it is possible to reduce the possibility of the coil spring contacting the projecting portion. Therefore, it is possible to reduce the possibility of unintentional adherence of the coil spring and the projecting portion.

The present invention can be realized with various modes. It is possible to realize the present invention, for example, as a membrane valve in a liquid container that can be installed in a liquid jetting device. The liquid container has a liquid storage chamber for storing liquid, a liquid supply port for supplying the liquid to the liquid jetting device, a first flow path linked to the liquid storage chamber, and a second flow path linked to the liquid supply port. The membrane valve is interposed between the first flow path and the second flow path.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an exploded perspective view of an ink cartridge as the first embodiment of the invention.

FIG. 2 is a drawing showing a state with the ink cartridge attached to a carriage.

FIG. 3 is a drawing conceptually showing the path that reaches from the air opening hole to the liquid supply section.

FIGS. 4 (A)-4 (B) are first drawings for describing the constitution of the valve section of the first embodiment.

FIGS. 5 (A)-5 (B) are first drawings showing the constitution of the membrane valve.

FIGS. 6 (A)-6 (B) are second drawings showing the constitution of the membrane valve.

FIG. 7 is a second drawing for describing the constitution of the valve section of the first embodiment.

FIG. 8 is a third drawing for describing the constitution of the valve section of the first embodiment.

FIG. 9 is a drawing for describing the constitution of the valve section 180 of the second embodiment.

FIG. 10 is a drawing for describing the constitution of the valve section 180 of the third embodiment.

FIG. 11 is a drawing for describing the constitution of the valve section 180 of the fourth embodiment.

FIGS. 12 (A) and 12 (B) are schematic diagrams showing the engagement of the membrane valve 500 and the spring seat member 300.

FIG. 13 is an explanatory drawing of the valve section.

FIGS. 14 (A) to 14 (C) are explanatory drawings showing the vicinity of the seal portion 520.

FIGS. 15 (A) and 15 (B) are explanatory drawings of the membrane valve 500.

FIGS. 16 (A) and 16 (B) are explanatory drawings of the membrane valve 500.

FIG. 17 is an exploded perspective view showing the constitution of the ink cartridge 100E.

FIG. 18 is an exploded perspective view showing the constitution of the ink cartridge 100E.

FIG. 19 is a side view of one side of the main body 110E.

FIG. 20 is a side view of the other side of the main body 110E.

FIGS. 21 (A) to 21 (C) are explanatory drawings of the membrane valve 500E.

FIGS. 22 (A) to 22 (C) are explanatory drawings of the spring seat member 300E.

FIG. 23 is an exploded perspective view of the valve assembly 600b.

FIGS. 24 (A) and 24 (B) are enlarged views of the side view of a part including the valve storage chamber 600a.

FIG. 25 is the E1-E1 cross section diagram of the valve section 180E.

FIGS. 26 (A) and 26 (B) are cross section diagrams of the valve section 180E.

FIG. 27 is the E1-E1 cross section diagram of the valve section 180E.

FIG. 28 is an explanatory drawing showing the constitution of the valve section 180F.

FIG. 29 is an explanatory drawing showing the constitution of the valve section 180G.

FIG. 30 is an exploded perspective view showing the constitution of the ink cartridge 100J.

FIGS. 31 (A) to 31 (D) are explanatory drawings of the membrane valve 500J.

FIGS. 32 (A) to 32 (C) are explanatory drawings of the spring seat member 300J.

FIG. 33 is an exploded perspective view of the valve assembly 600bJ.

FIG. 34 is an explanatory drawing showing a modified embodiment.

FIG. 35 is an explanatory drawing showing a modified embodiment.

FIG. 36 is an explanatory drawing showing a modified embodiment.

### DESCRIPTION OF THE PREFERRED EMBODIMENT

Following, embodiments of the invention will be described. With the description of the embodiments, high/low and up/down use the direction of gravitational force as the standard, and the top surface, bottom surface, front, back, left, and right use the state with the liquid container placed in the liquid consumption device as the standard. Here, when the gravitational force direction bottom side is the first surface, the surface facing opposite the first surface (the gravitational force direction top side surface) is the second surface, the wide surfaces facing opposite each other that cross the first and second surfaces are the third and fourth surfaces, and the narrow surfaces that face opposite each other that cross the first through fourth surfaces are the fifth and sixth surfaces, with this embodiment, the first surface is the bottom surface, the second surface is the top surface, the third surfaces is the first side surface, the fourth surface is the second side surface, the fifth surface is the front surface, and the sixth surface is the back surface.

Also, though this will be described in detail later, with all of the embodiments, the valve upstream path 170 is linked to the upstream chamber 181. Also, the valve downstream path 190 is linked to the downstream valve chamber 182 (via the spring accommodating chamber 184). Therefore, with all of the embodiments, the membrane valve 500 and the like is interposed between the valve upstream path 170 and the valve downstream path 190.

Also, with the second through ninth embodiments, the description will focus on a part that is different from any of the previously described embodiments. With these embodiments, for elements given the same shared code number as elements described previously, the constitution, materials, modified embodiments and the like common to the elements described previously are applied.

### A. First Embodiment

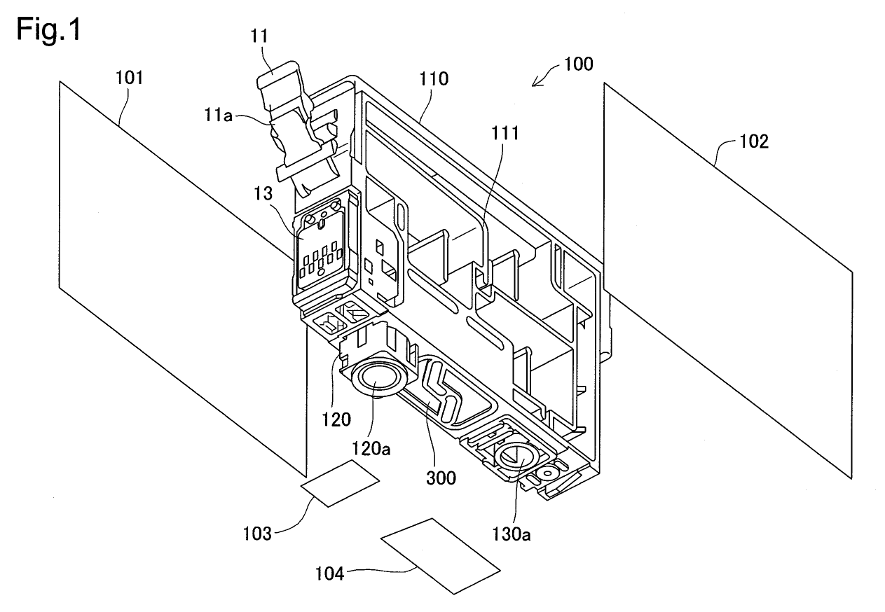

FIG. 1 is an exploded perspective view of an ink cartridge as the first embodiment of the invention. The ink cartridge 100 is equipped with a main body 110, a first side film 101, a second side film 102, a first bottom film 103, and a second bottom film 104.

Provided on the bottom surface of the main body 110 is an ink supply section 120 which has a supply port 120a for supplying ink to an inkjet printer. At the bottom surface of the main body 110 is opened an air opening hole 130a for introducing the atmosphere inside the ink cartridge 100. A spring seat member 300 is fit on the bottom surface of the main body 110. An engaging lever 11 is provided on the front surface of the main body 110. A projection 11a is formed on the engaging lever 11. A circuit board 13 is provided on the lower side of the engaging lever 11 of the front of the ink cartridge 100. A plurality of electrode terminals are formed on the circuit board 13, and when installing in a liquid jetting device, the electrical connection of these electrode terminals to the inkjet printer is made via the electrode terminals on the device side. Ribs 111 having various shapes are formed on both side surfaces of the main body 110. The side films 101 and 102 are adhered on the main body 110 so as to cover the entirety of both side surfaces of the main body 110. The side films 101 and 102 are adhered closely so that gaps do not occur between the end surface of the ribs 111 and the side films 101 and 102. With these ribs 111 and side films 101 and 102, on the interior of the ink cartridge 100, a plurality of compartments, for example the ink storage chamber, the buffer chamber, or the ink flow path described later are formed as compartments. Similarly, the first bottom film 103 is adhered on the front end part of the bottom surface of the ink cartridge 100, and the second bottom film 103 is adhered on the bottom surface of the spring seat member 300, and the ink flow path is formed as a compartment together with the adhered members.

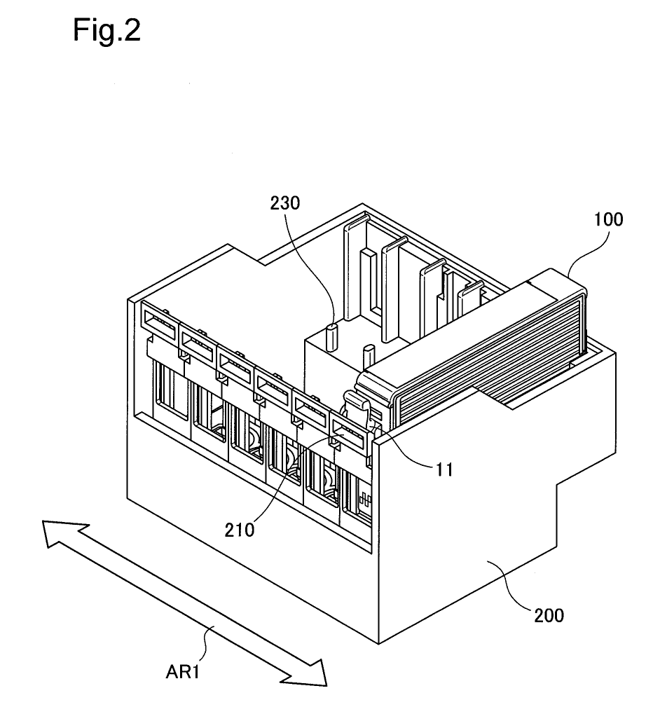

FIG. 2 is a drawing showing a state with the ink cartridge attached to a carriage. The air opening hole 130a has a depth and diameter so as to fit with a margin so that the projections 230 formed on the cartridge 200 of the inkjet printer have a specified gap. The ink cartridge 100 is fixed to the carriage 200 by having the projection 11a of the engaging lever 11 engage with the concave portion 210 formed in the carriage 200 when installed in the carriage 200. During printing with the inkjet printer, the carriage 200 becomes one unit with the printing head (not illustrated), and moves back and forth in the paper width direction of the printing medium (main scan direction). The main scan direction is as shown by arrow AR1 in FIG. 2.

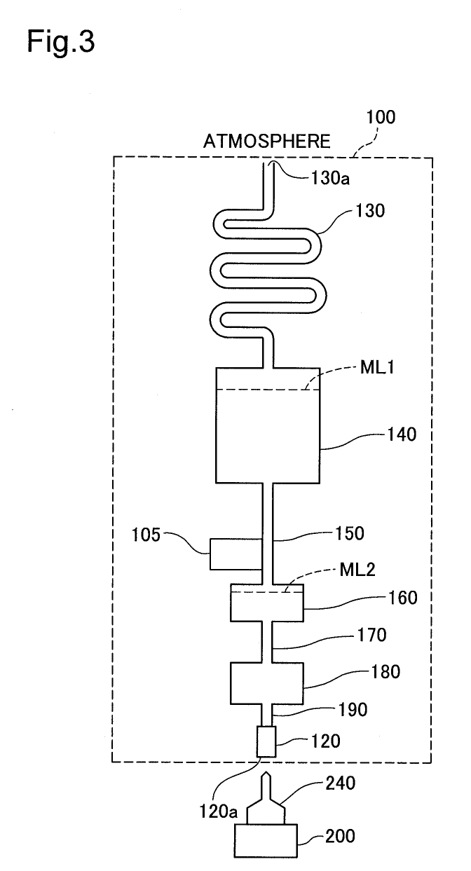

FIG. 3 is a drawing conceptually showing the path that reaches from the air opening hole to the liquid supply section. The ink path is described which is compartmentalized by the main body 110, the spring seat member 300, and the films 101 to 104 described above. This ink path contains in sequence from upstream a serpentine path 130, an ink storage chamber 140, an intermediate flow path 150, a buffer chamber 160, a valve upstream path 170, a valve section 180, a valve downstream path 190, and an ink supply section 120. The serpentine path 130 has the upstream end linked to the air opening hole 130a, and the downstream end linked to the upstream side of the ink storage chamber 140 via the gas-liquid separation membrane (not illustrated). The serpentine path 130 is formed long and thin and in serpentine fashion so as to make the distance from the air opening hole 130a to the ink storage chamber 140 longer. By doing this, it is possible to suppress evaporation of the moisture in the ink within the ink storage chamber 140. The gas-liquid separation membrane is constituted as a component that allows transmission of gases while not allowing transmission of liquid.

The downstream side of the ink storage chamber 140 is linked to the upstream end of the intermediate flow path 150, and the downstream end of the intermediate flow path 150 is linked to the upstream side of the buffer chamber 160. The downstream side of the buffer chamber 160 is linked to the upstream end of the valve upstream path 170, and the downstream end of the valve upstream path 170 is linked to the upstream side of the valve section 180. The downstream side of the valve section 180 is linked to the upstream end of the valve downstream path 190, and the downstream end of the valve downstream path 190 is linked to the ink supply section 120. When the ink cartridge 100 is installed in the inkjet printer, an ink supply needle 240 equipped on the carriage 200 is inserted in the supply port 120a of the ink supply section 120. The ink inside the ink cartridge 100 is supplied via the ink supply needle 240 for printing by the inkjet printer.

A sensing section 105 is arranged in contact with the intermediate flow path 150. With FIG. 1, the sensing section 105 is arranged in the space at the back side of the circuit board 13. Though omitted from the drawing, the sensing section 105 is equipped with a cavity that forms part of the wall surface of the intermediate flow path 150, a vibrating plate forming part of the cavity wall surface, and a piezoelectric element arranged on the vibrating plate. The terminal of the piezoelectric element is electrically connected to part of the electrode terminal of the circuit board 13, and when the ink cartridge 100 is installed in the inkjet printer, the terminal of the piezoelectric element is electrically connected to the inkjet printer via the electrode terminal of the circuit board 13. The inkjet printer can make the vibrating plate vibrate via the piezoelectric element by applying electrical energy to the piezoelectric element. After that, by detecting via the piezoelectric element the characteristics (frequency and the like) of the residual vibration of the vibrating plate, the inkjet printer is able to detect the presence or absence of ink in the cavity. In specific terms, by the ink stored in the ink cartridge 100 being used up, when the cavity internal state changes from an ink-filled state to an air-filled state, the characteristics of the residual vibration of the vibrating plate change. By these changes in the vibrating characteristics being detected via the piezoelectric element, the inkjet printer is able to detect the presence or absence of ink in the cavity.

When manufacturing the ink cartridge 100, as the liquid surface is conceptually shown by the dashed line ML1, the ink is filled up to the ink storage chamber 140. As the ink inside the ink cartridge 100 is consumed by the inkjet printer, the liquid surface moves to the downstream side, and in its place, air flows in to inside the ink cartridge 100 from upstream via the air opening hole 130a. Then, when ink consumption advances, as the liquid surface is conceptually shown by the dashed line ML2, the liquid surface reaches the sensing section 105. When this is done, air is introduced into the cavity of the sensing section 105, and running out of ink is detected by the piezoelectric element of the sensing section 105. When running out of ink is detected, the ink cartridge 100 stops printing at the stage before the ink existing at the downstream side of the sensing section 105 (buffer chamber 160 and the like) is completed consumed, and notifies the user that the ink is running out. This is because there is the risk that when the ink completely runs out, when further printing is performed, air is mixed into the printing head, which would cause problems.

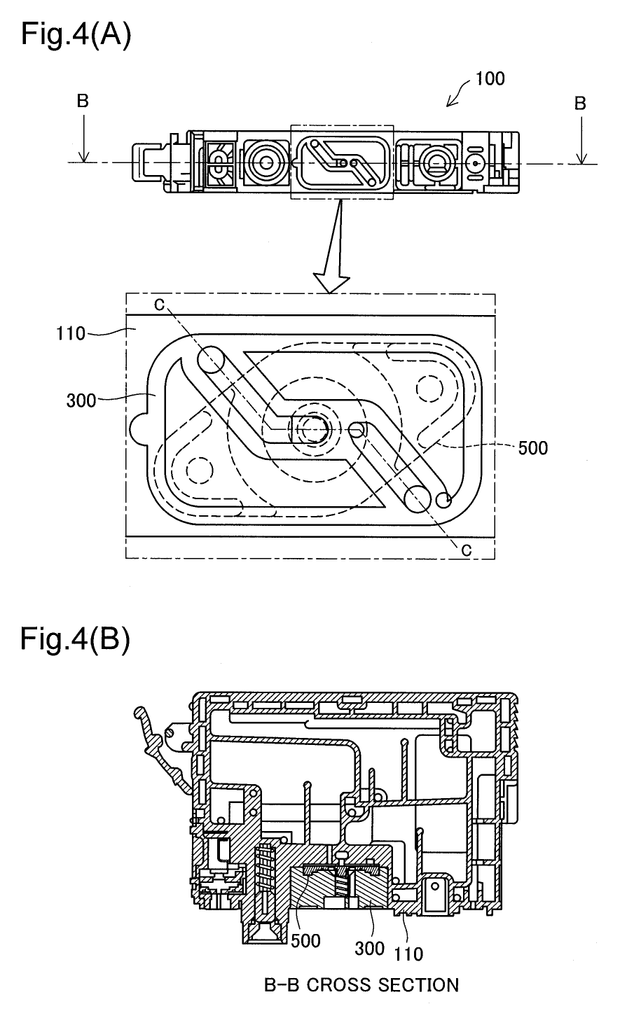

FIG. 4 are first drawings for describing the constitution of the valve section. The valve section 180 includes a spring seat member 300 arranged at roughly the center of the bottom surface of the main body 110, and a membrane valve 500 arranged between the top surface of the spring seat member 300 and the main body 110.

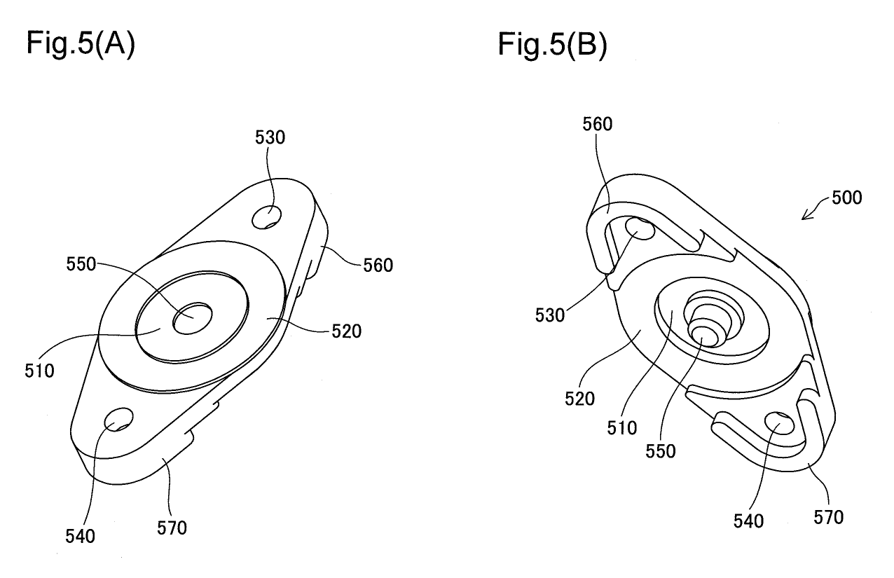

FIG. 5 are first drawings showing the constitution of the membrane valve 500. The membrane valve 500 is created with a resin type elastomer which has overall elasticity. The specific gravity of the elastomer used with the membrane valve 500 is smaller than the specific gravity of the ink. The membrane valve 500 has an axis portion 550, a membrane portion 510, a seal portion 520, a first installing portion 560, and a second installing portion 570. Of the surfaces of the membrane valve 500, the side shown in FIG. 5 (A) is called the first surface. Meanwhile, of the surfaces of the membrane valve 500, the side shown in FIG. 5 (B) is called the second surface. A first assembly hole 530 is formed on the first installing portion 560, and a second assembly hole 540 is formed on the second installing portion 570. By fitting these assembly holes 530 and 540 in the convex part (not illustrated) of the top part of the spring seat member 300, the membrane valve 500 is fixed to the top part of the spring seat member 300.

The membrane portion 510 has a ring shape that encloses the periphery of the axis portion 550. The seal portion 520 has a ring shape that encloses the outer periphery of the membrane portion 510.

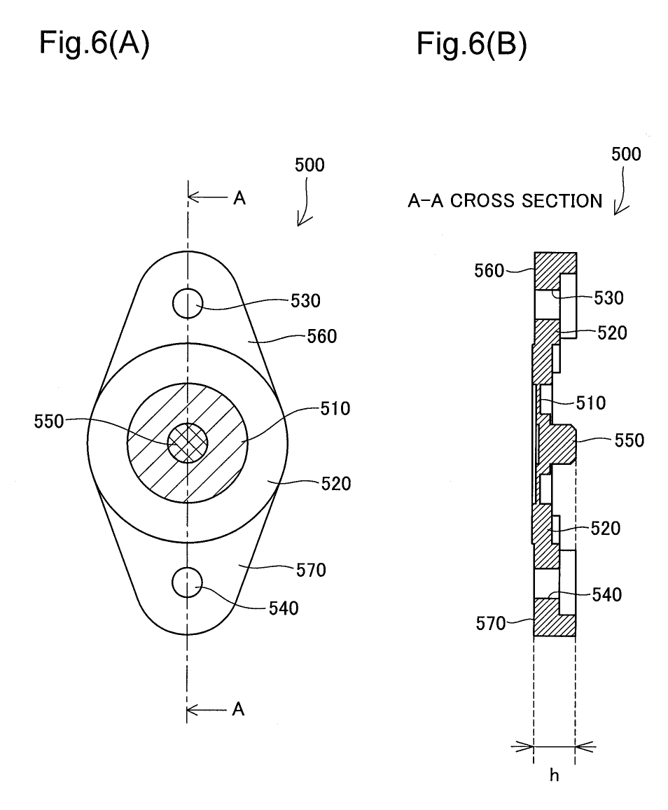

FIG. 6 are second drawings showing the constitution of the membrane valve 500. FIG. 6 (A) is a front view of the membrane valve 500 seen from the first surface side. FIG. 6 (B) is a drawing showing the A-A cross section of FIG. 6 (A). In the part of the first surface side of the axis portion 550, specifically, in FIG. 6 (A), the cross hatched area is the contact area that is in contact with that is contact with the upstream end of the relay flow path described later. The membrane portion 510 has a thickness that is relatively thin compared to other parts as shown in FIG. 6 (B), so it is deformed easily. In the part of the first surface side of the membrane portion 510, specifically, in FIG. 6 (A), the single-hatched area is the upstream side pressure receiving area that receives the fluid pressure of the ink that flows in the valve upstream path 170. The side opposite the upstream side pressure receiving area, specifically, the second surface side, is the downstream side pressure receiving area that receives the fluid pressure of ink that flows in the valve downstream path 190. As shown in FIG. 6 (B), the maximum thickness of the first installing portion 560, the maximum thickness of the second installing portion 570, and the maximum thickness of the axis portion 550 are designed to have an equal value h. This is because it is possible to laminate a plurality of the membrane valve 500 stably when transporting the plurality of the membrane valve 500 as parts.

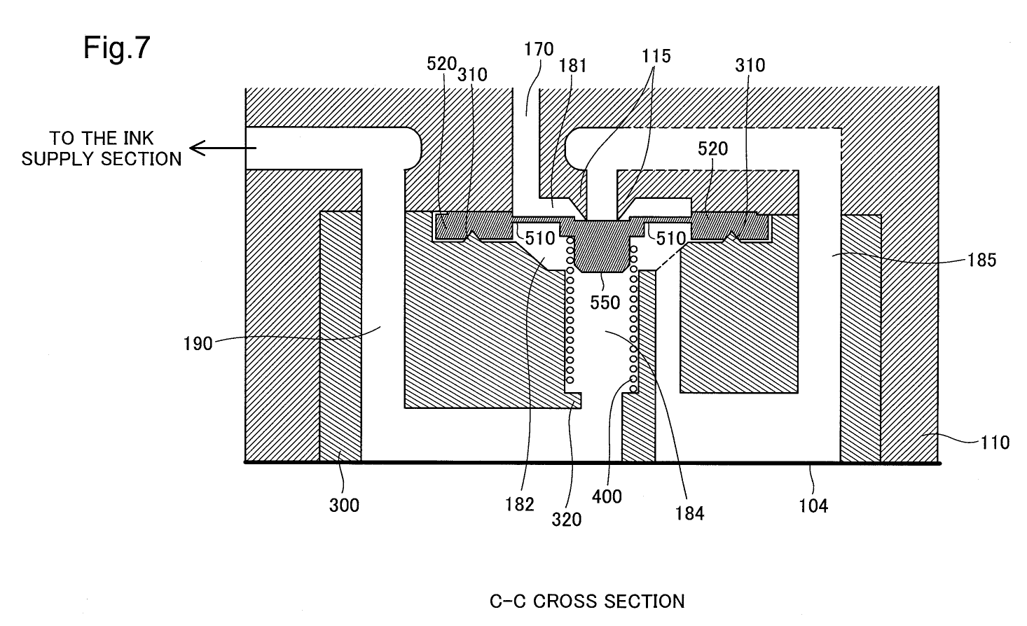

FIG. 7 is a second drawing for describing the constitution of the valve section 180. FIG. 7 corresponds to the C-C cross section in FIG. 4. FIG. 7 shows the closed valve state (non-linked state) for which the membrane valve 500 blocks the link between the valve upstream path 170 and the valve downstream path 190. As can be understood from FIG. 7, in a state with the ink cartridge 100 installed in the carriage 200, the contact area is low or sinks in from the upstream side pressure receiving area, and is in a low position in the gravitational force direction. Formed on the valve section 180 are an upstream valve chamber 181, a downstream valve chamber 182, a spring accommodating chamber 184, and a relay flow path 185. The upstream valve chamber 181 is formed as a compartment by a shape formed on the main body 110 and the first surface of the membrane valve 500. The downstream valve chamber 182 is formed as a compartment by a shape formed on the spring seat member 300 and the second surface of the membrane valve 500. The downstream valve chamber 182 has a tapered shape that is deeper the closer it goes toward the center of the circle, and becomes shallower the more it goes toward the outside. The spring accommodating chamber 184 is formed on the spring seat member 300 and has a round cylinder shape. A coil spring 400 is stored as the urging member in the spring accommodating chamber 184. The top end of the spring accommodating chamber 184 is linked to the downstream valve chamber 182, a spring supporting portion 320 that supports the spring is formed at the lower side of the spring accommodating chamber 184, and the lower side of the spring accommodating chamber 184 is linked to the valve downstream path 190. As shown in the drawing, with the valve downstream path 190, the upstream part is formed as a compartment by the shape formed on the spring seat member 300 and the second bottom film 104, and the downstream part is formed on the main body 110. With the relay flow path 185, the upstream part is formed on the main body 110, and the downstream part is formed as a compartment by the shape formed on the spring seat member 300 and the second bottom film 104. The upstream end part of the relay flow path 185 has an apex shape 115, and is in contact with the contact area of the membrane valve 500 when in a closed valve state. The downstream end of the relay flow path 185 is linked to the downstream valve chamber 182.

The coil spring 400 urges the axis portion 550 of the membrane valve 500 in the direction toward the top side. Also, the fluid pressure of the valve downstream path 190 is applied to the second surface of the membrane valve 500 via the downstream valve chamber 182. This urging force and the fluid pressure of the valve downstream path 190 become the force that tries to maintain the closed valve state of the membrane valve 500 (closed valve force). Meanwhile, the fluid pressure of the valve upstream path 170 is applied to the first surface of the membrane valve 500. The fluid pressure of this valve upstream path 170 becomes the force that tries to achieve the open valve state of the membrane valve 500 (open valve force).

The seal portion 520 of the membrane valve 500 is gripped between the main body 110 and the spring seat member 300. With the spring seat member 300, at the part that grips the seal portion 520, the cross section is triangular, and a ring shaped rib 310 is formed when seen from the top surface. By the rib 310 being pressed against the seal portion 520, leaking of the ink to outside the seal portion 520 is suppressed.

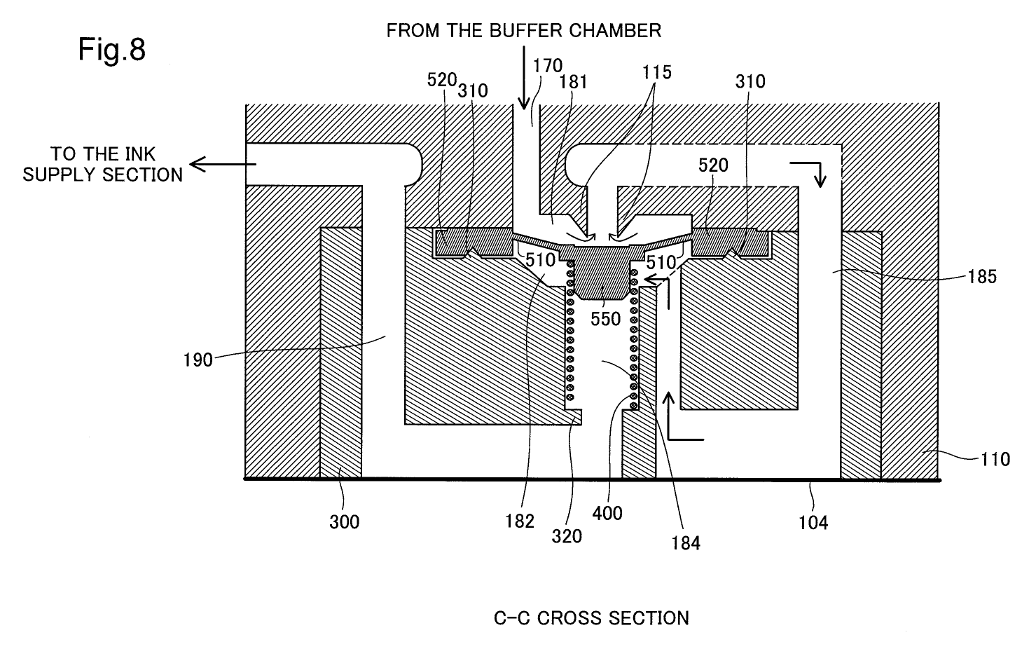

FIG. 8 is a third drawing for describing the constitution of the valve section 180 of the first embodiment. When ink is consumed by the inkjet printer, ink is supplied from the ink supply section to the inkjet printer. By doing this, the fluid pressure of the valve downstream path 190 decreases. If the closed valve force in relation to the membrane valve 500 by the decrease of the fluid pressure of the valve downstream path 190 becomes lower than the open valve force in relation to the membrane valve 500, the membrane portion 510 of the membrane valve 500 is deformed, and the axis portion 550 moves downward. As a result, a gap is formed between the apex shape 115 and the contact area of the membrane valve 500, and the valve upstream path 170 goes to a state linked to the valve downstream path 190 via the relay flow path 185 and the downstream valve chamber 182 (open valve state). With this open valve state, ink is flowed into the relay flow path 185 from the valve upstream path 170, and as a result, ink flows into the valve downstream path 190. By this inflow of ink, the fluid pressure of the valve downstream path 190 rises, and as a result, when the valve close force exceeds the valve open force, the membrane portion 510 is again deformed, and the membrane valve 500 returns to a closed valve state.

Because the urging force of the coil spring 400 is added, the fluid pressure of the valve downstream path 190 is kept lower than the fluid pressure of the valve upstream path 170 which receives atmospheric pressure. Specifically, the pressure of the ink inside the valve downstream path 190 is normally kept at a negative pressure lower than atmospheric pressure, and as a result, it is possible to suppress ink leakage from the ink supply section 120 of the ink cartridge 100.

With the first embodiment described above, the membrane valve 500 is formed using an elastomer, so the deformation of the membrane portion 510 in relation to the fluid pressure is stabilized. As a result, the negative pressure generated in the ink inside the valve downstream path 190 is also stabilized.

Furthermore, the membrane valve 500 is arranged so that the membrane portion 510 is roughly perpendicular in relation to the gravitational force direction. As a result, there is little variation due to gravitational force of the fluid pressure applied to the membrane portion 510. As a result, the deformation of the membrane portion 510 is stabilized, so the negative pressure generated in the ink inside the valve downstream flow path 190 is also stabilized.

Furthermore, with the state in which the ink cartridge 100 is installed in the carriage 200, the contact area of the first surface of the membrane valve 500 is in a position lower than the upstream side pressure receiving area, so ink is not easily left remaining in the upstream valve chamber 181. As a result, the ink volume remaining inside the ink cartridge 100 is suppressed, and it is possible to supply a greater amount of ink to the inkjet printer.

Furthermore, the specific gravity of the membrane valve 500 is lower than the specific gravity of the ink, so force is applied by the buoyancy force on the membrane valve 500 to the upper side. As a result, it is possible to make the coil spring 400 compact.

### B. Second Embodiment

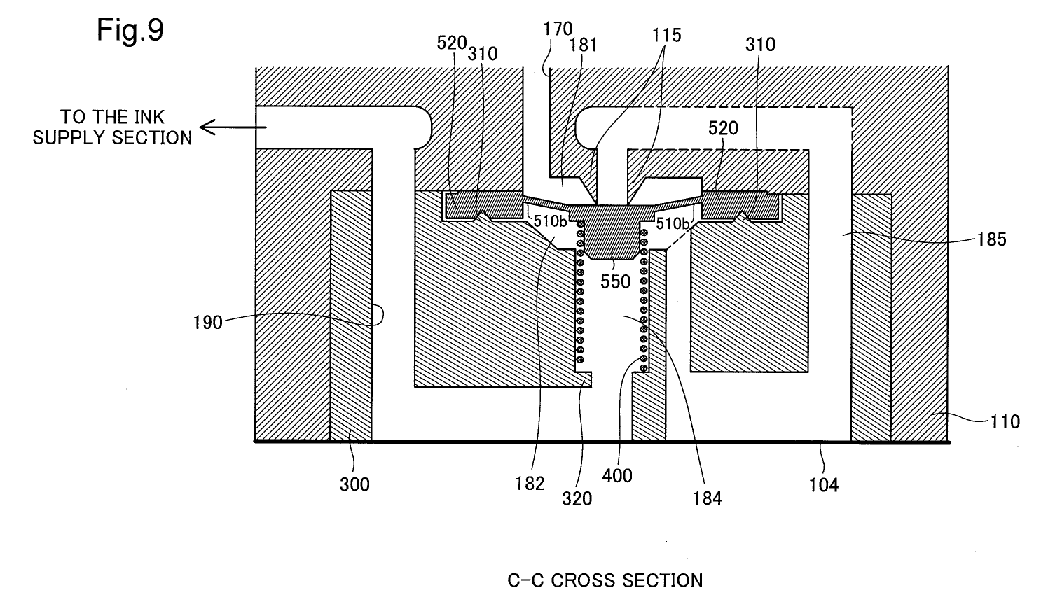

FIG. 9 is a drawing for describing the constitution of the valve section 180 of the second embodiment. With the membrane portion 510b of the second embodiment, in contrast to the membrane portion 510b of the first embodiment, this is formed diagonally rather than horizontally in the closed valve state of the membrane valve 500. Specifically, 510b of the second embodiment has an incline that is lower the more it faces the center of the membrane valve 500, and higher the more it faces the outside of the membrane valve 500. As a result, the fluid of the upstream valve chamber 181 is gathered near the contact area, so ink does not easily remain in the upstream valve chamber 181. As a result, the ink volume that remains inside the ink cartridge 100 is suppressed, and it is possible to supply a larger volume of ink to the inkjet printer.

### C. Third Embodiment

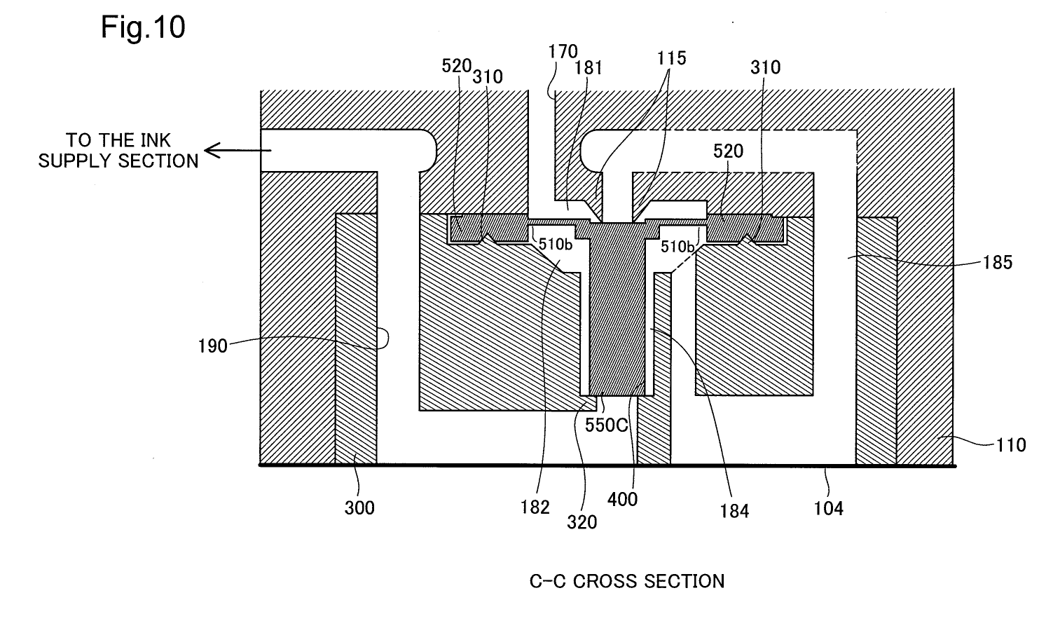

FIG. 10 is a drawing for describing the constitution of the valve section 180 of the third embodiment. There is no coil spring 400 in the valve section 180 of the third embodiment. With the membrane valve 500 of the third embodiment, the axis portion 550c is extended along the lower side, and reaches the spring supporting portion 320. Specifically, the cylindrical part of the bottom of the axis portion 550 functions in place of the coil spring 400 as an urging member that urges the membrane valve 500 to the apex shape 115 side. Working in this way, by making the membrane valve 500 and the urging member a single unit, it is possible to reduce the number of parts.

### D. Fourth Embodiment

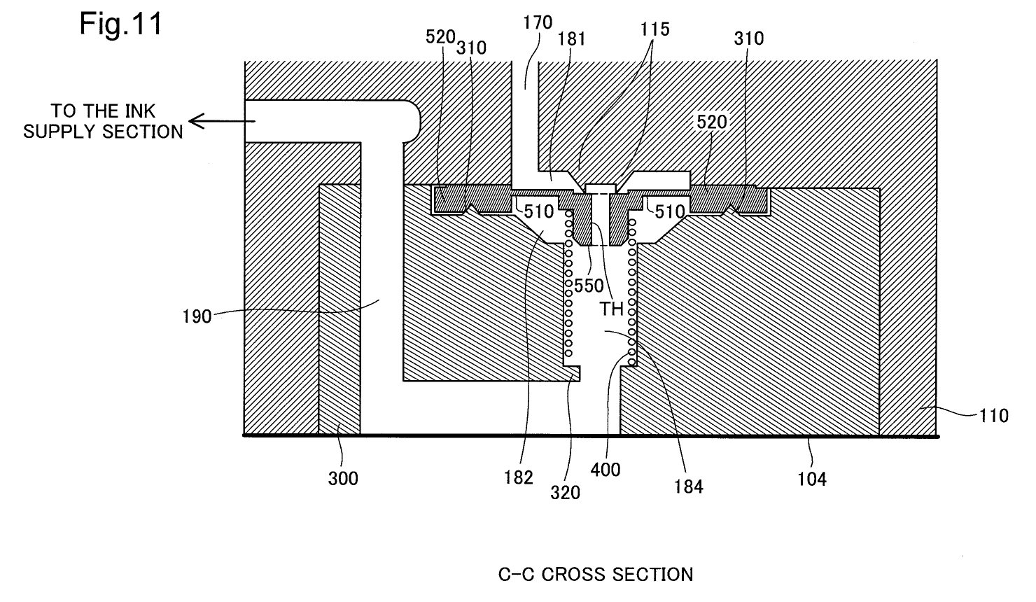

FIG. 11 is a drawing for describing the constitution of the valve section 180 of the fourth embodiment. With the fourth embodiment, in contrast to the first embodiment, the relay flow path 185 is not formed. A through hole TH that goes through the axis portion 550 in the axis direction is formed on the membrane valve 500 of the fourth embodiment. Seen from the top surface, the through hole TH is provided further inside than the contact part with the apex shape 115 at the contact area of the axis portion 550. With the fourth embodiment, in the open valve state, the valve upstream path 170 is linked to the valve downstream path 190 via the through hole TH. With the fourth embodiment as well, the same operation and effects are exhibited as with the first embodiment.

Note that with the second through fourth embodiments, only the parts that differ from the first embodiment is described, but the other portions can be constituted in the same way as the first embodiment, and for the portions constituted in the same way as the first embodiment, it is possible to obtain the same effect as the first embodiment.

### E. Fifth Embodiment

Next, a more detailed constitution of the first embodiment and a modified embodiment are will described as the fifth embodiment.

First, as the material of the membrane valve 500, besides the elastomer noted with the first embodiment, it is possible to use various other elastic materials. As an elastic material other than the elastomer, silicon can be used, for example. Here, the more flexible the material of the membrane valve 500 (in particular the membrane portion 510), the greater the deformation of the membrane portion 510 with the same differential pressure. As a result, it is possible to make the valve section 180 more compact. From this kind of perspective, for example, it is possible to use a material for which the hardness level stipulated in Japanese JIS K 6523 is level 22 or lower. It is particularly good to use a material of hardness level 4. If a flexible material is used in this way, it is possible to suitably open and close a valve using a small membrane valve. As this kind of flexible material, for example, it is possible to use the materials noted in Japanese Unexamined Patent Gazette 2000-978. Also, the entire membrane valve 500 of the first embodiment can be formed as a single unit, but it is also possible to form the membrane valve 500 by adhering a plurality of parts or the like. Note that in this specification, there are cases of expression with part of the membrane valve being affixed to another part, but even when the overall membrane valve 500 is formed as a single unit as with the first embodiment, it is possible to express part of the membrane valve 500 as “affixed” to another part. For example, it is possible to have the first installing portion 560 be affixed to the seal portion 520.

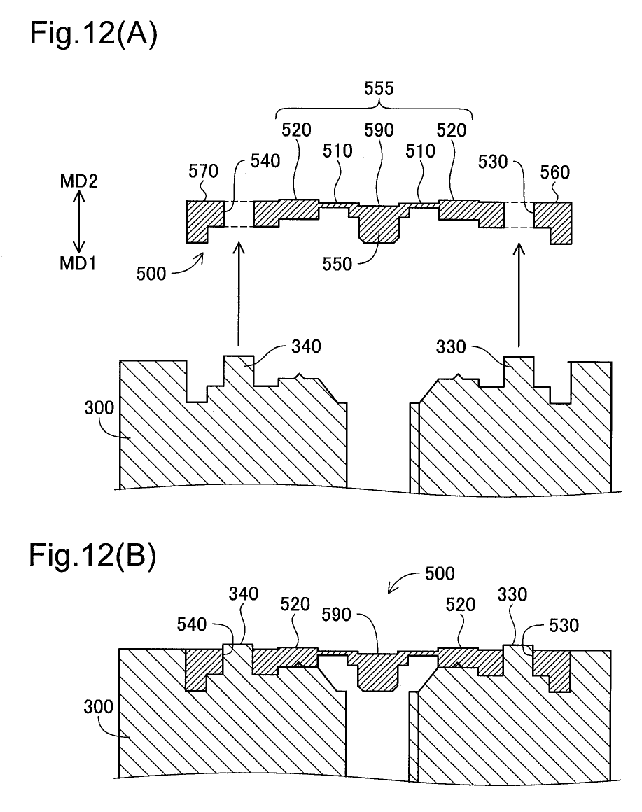

FIG. 12 are schematic diagrams showing the engagement of the membrane valve 500 with the spring seat member 300. Shown in FIG. 12 are expanded views of the membrane valve 500 and the spring seat member 300 shown in FIG. 4 (B). The cross section view of membrane vale 500 in the drawing is the same as the cross section view of FIG. 6 (B). FIG. 12 (A) shows the state before the membrane valve 500 is installed in the spring seat member 300, and FIG. 12 (B) shows the state when the membrane valve 500 is installed (supported) in the spring seat member 300. The directions MD1 and MD2 in the drawing show the movement direction of the contact area 590 according to deformation of the membrane portion 510. The first movement direction MD1 is the direction with which the contact area 590 separates from the apex shape 115 (FIG. 8). The second direction MD2 is the reverse direction of the first direction MD1. As shown in FIG. 7 and FIG. 8, the contact area 590 movement directions MD1 and MD2 are directions perpendicular to the contact area 590.

As shown in FIG. 6 (B), the holes 530 and 540 of the membrane valve 500 respectively extend along the same direction as the movement directions MD1 and MD2. The convex parts 330 and 340 described above (also called axes 330 and 340) are respectively provided on the surface on which the membrane valve 500 of the spring seat member 300 is installed. As shown in FIG. 12 (B), in the state with the membrane valve 500 installed in the spring seat member 300, the two axes 330 and 340 are respectively inserted in the two holes 530 and 540. As a result, it is possible to uniquely determine the position of the membrane valve 500 (specifically, the contact area 590) intersecting direction with the movement directions MD1 and MD2. Also, it is possible to reduce the possibility of position skew of the intersecting direction of the contact area 590. Therefore, it is possible to reduce the possibility of contact failure between the contact area 590 and the apex shape 115, so it becomes possible to suitably open and close the valve. It is also possible to install the membrane valve 500 in the spring seat member 300 using a simple method of inserting the axes 330 and 340 in the holes 530 and 540.

Note that these axes 330 and 340 respectively extend parallel to the movement directions MD1 and MD2. These axes 330 and 340 are respectively circular column shapes. The size and shape of the axis 330 and the hole 530 are acceptable as long as at least part of the inner surface of the hole 530 is made to contact the side surface of the axis 330 in the state shown in FIG. 12 (B). Similarly, the size and shape of the axis 340 and the hole 540 are acceptable as long as at least part of the inner surface of the hole 540 is made to contact the side surface of the axis 340. If the axes 330 and 340 and the holes 530 and 540 are made to be this kind of size and shape, it is possible to suitably reduce the possibility of position skew of the contact area 590. With this embodiment, the inner diameter of the hole 530 and the outer diameter of the axis 330 are almost the same. Thus, it is possible to easily have at least part of the inner surface of the hole 530 be in contact with the side surface of the axis 330. Meanwhile, it is also possible to have the inner diameter of the hole 530 be smaller than the outer diameter of the axis 330. By doing this, it is possible to make the contact area between the hole 530 and the axis 330 larger, and it is possible to have the side surface of the axis 330 contact over the entire periphery of the inner surface of the hole 530. Therefore, it is possible to reduce the possibility of the hole 530 falling off the axis 330. Note that if the absolute value of the difference between the outer diameter of the axis 330 and the inner diameter of the hole 530 is within 5% of the inner diameter of the hole 530, then it is possible to have the inner diameter of the hole 530 be almost the same as the outer diameter of the axis 330. Here, the absolute value of the difference is preferably within 1% of the outer diameter of the axis 330. By doing this, it is easy to insert the axis 330 into the hole 530, and then it is possible to have the side surface of the axis 330 suitably contact at least part of the inner surface of the hole 530. The description above is the same for the hole 540 and the axis 340 as well.

Note that the round disk part that has the seal portion 520 as the outer periphery (the entirety of the seal portion 520, membrane portion 510, and axis portion 550) of the membrane valve 500 (FIG. 5, FIG. 6, FIG. 12) correlates to the “valve main portion” (also called “valve main portion 555” hereafter). Also, the first installing portion 560 correlates to the “first attachment portion,” and the second installing portion 570 correlates to the “second attachment portion.” The entirety of these installing portions 560 and 570 correlates to the “attachment portion.” When the contact area 590 separates from the apex shape 115, the valve upstream path 170 and the valve downstream path 190 are linked. When, the contact area 590 is pressed against the apex shape 115, and between the valve upstream path 170 and the valve downstream path 190 is blocked (FIG. 7 and FIG. 8). In this way, the contact area 590 correlates to the “movable seal (movable portion),” and the apex shape 115 correlates to the “seal receiving portion.” The spring seat member 300 that supports the membrane valve 500 correlates to the “membrane support portion.” The holes 530 and 540 respectively correlate to the “engaging portion (engaging hole).” The axes 330 and 340 respectively correlate to the “engaging axes.” Also, the spring accommodating chamber 184 shown in FIG. 7 and FIG. 8 correlates to the “concave portion for receiving the end of the coil spring 400.”

Here, as shown in FIG. 6, the first installing portion 560 (first attachment portion) is affixed to part of the outer periphery of the looped seal portion 520 (valve main portion 555). Also, the second installing portion 570 (second attachment portion) is affixed to part of the remaining part of the outer periphery seal portion 520 (valve main portion 555). In this way, the attachment portion (560, 570) is affixed only to part of the outer periphery of the seal portion 520 (valve main portion 555). Therefore, compared to when an attachment part is affixed in a loop shape to the entire periphery of the seal portion 520 (valve main portion 555), it is possible to make the membrane valve 500 compact. Note that as shown in FIG. 6, the shape of the membrane valve 500 is a roughly diamond shape for which the first installing portion 560 and the second installing portion 570 are diagonal.

Note that the first surface of the membrane valve 500 shown in FIG. 5 (A) is a “valve upstream path 170 side surface” as shown in FIG. 7, and the second surface of the membrane valve 500 shown in FIG. 5 (B) is the “valve downstream path 190 side surface” as shown in FIG. 7. Here, when tracing the flow of a fluid, the “valve upstream path 170 side surface” means the surface arranged at the valve upstream path 170 side rather than at the valve downstream path 190 side. When tracing the flow of the fluid, the “valve downstream flow path 190 side surface” means the surface arranged on the valve downstream path 190 side rather than the valve upstream path 170 side.

Furthermore, in relation to the membrane valve 500, as shown below, it is possible to reduce the possibility of an unintended deformation of the valve main portion 555. For example, it is assumed that a method is being used by which the position of the valve main portion 555 is determined by providing an edge (brim, flange) that projects from the seal portion 520 onto the overall outer periphery of the seal portion 520 and inserting the edge of this loop shape (e.g. a round cylinder shape) into a loop shaped groove. In this case, there is the possibility that the “edge” will not be arranged evenly at the loop shaped groove and local position skew will occur. With this assumed example, the entire outer periphery of the valve main portion 555 is used for position determination, so this kind of local position skew can cause unintentional deformation of the valve main portion 555. Meanwhile, in case of the membrane valve 500 of FIG. 6, with the attachment portion (installing portions 560 and 570) affixed to part of the outer periphery of the seal portion 520 (valve main portion 555), the position of the valve main portion 555 is determined. Furthermore, with this embodiment, the position of the valve main portion 555 is determined using a simple constitution of having the axes 330 and 340 respectively inserted in the holes 530 and 540 formed on the installing portions 560 and 570. Therefore, it is possible to reduce the possibility of adding unintentional force to the outer periphery of the seal portion 520 (valve main portion 555). As a result, it is possible to reduce the possibility of unintentional deformation of the valve main portion 555 due to position determination.

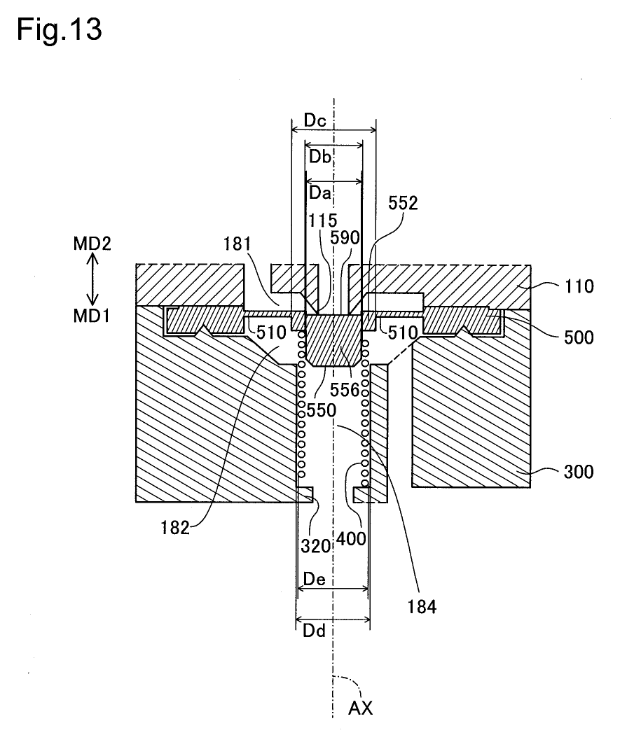

FIG. 13 shows a part including the membrane valve 500, the coil spring 400, and the spring accommodating chamber 184 of the same cross section as FIG. 7. The code number 552 in the drawing shows a spring receiving portion. The spring receiving portion 552 is part of the membrane valve 500, and is a part that receives one end of the coil spring 400. The thickness of the spring receiving portion 552 is thicker than the thickness of the membrane portion 510, so it is possible to reduce the possibility of damage to the membrane valve 500 by the coil spring 400. Also, the spring receiving portion 552 surrounds the circumference of the projecting portion 556 (the part inserted in the inside of one end of the coil spring 400) of the axis portion 550. The membrane portion 510 is affixed to the circumference of the spring receiving portion 552. Note that the projecting portion 556 of the axis portion 550 projects along the first movement direction MD1. Also, the spring accommodating chamber 184 extends along the movement direction MD1, and the coil spring 400 urges the contact area 590 in the second direction MD2 (facing the apex shape 115).

In the drawing, further shown are the dimensions Da to De. The outer diameter Da shows the outer diameter of the projecting portion 556, the inner diameter Db shows the inner diameter of the coil spring 400, the outer diameter Dc shows the outer diameter of the spring receiving portion 552, the inner diameter Dd shows the inner diameter of the spring accommodating chamber 184, and the outer diameter De shows the outer diameter of the coil spring 400. As shown in the drawing, with this embodiment, the outer diameter Da of the projecting portion 556 and the inner diameter Db of the coil spring 400 are almost the same. Therefore, by inserting the projecting portion 556 inside one end of the coil spring 400, the side surface of the projecting portion 556 is in contact with the inner surface of the coil spring 400. Also, it is possible to reduce the possibility of skew of the position of the coil spring 400 (in particular, the position in the direction perpendicular to the movement directions MD1 and MD2) in relation to the projecting portion 556 (and thus the contact area 590). As a result, it is possible to suitably urge the contact area 590, so it is possible to suitably open and close the valve. Note that if that the absolute value of the difference between the outer diameter Da and the inner diameter Db is within 5% of the outer diameter Da, then it is possible to have the outer diameter Da be substantially almost the same as the inner diameter Db. Here, if the absolute value of the difference between the outer diameter Da and the inner diameter Db is within 1% of the outer diameter Da, it is possible to further reduce the possibility of position skew.

Also, as shown in the drawing, with this embodiment, the spring receiving portion 552, the projecting portion 556, and the spring accommodating chamber 184 are arranged on the same axis. The axis AX in the drawing shows the central axis common to each element. This axis AX is parallel with the movement directions MD1 and MD2. Also, the outer diameter Dc of the spring receiving portion 552 is bigger than the inner diameter Dd of the spring accommodating chamber 184. Therefore, it is possible to reduce the possibility of the position of the coil spring 400 being displaced within the spring accommodating chamber 184 and the end part of the coil spring 400 coming off the spring receiving portion 552. Note that the cross section shape perpendicular to the axis AX of the apex shape 115, the membrane portion 510, the spring receiving portion 552, the projecting portion 556, and the spring accommodating chamber 184 is roughly circular shaped.

Also, the inner diameter Dd of the spring accommodating chamber 184 is bigger than the outer diameter De of the coil spring 400. By doing this, it is possible to lighten the friction between the coil spring 400 and the spring accommodating chamber 184, so it is possible to make the expansion and contraction of the coil spring 400 smooth. Also, it is possible to easily insert the coil spring 400 in the spring accommodating chamber 184.

Also, the contact area 590 is formed inside the spring receiving portion 552 (the position of the direction perpendicular to the movement directions MD1 and MD2 is within the range enclosing the spring receiving portion 552). Therefore, the membrane valve 500 is able to suitably convey the urging force by the coil spring 400 to the contact area 590.

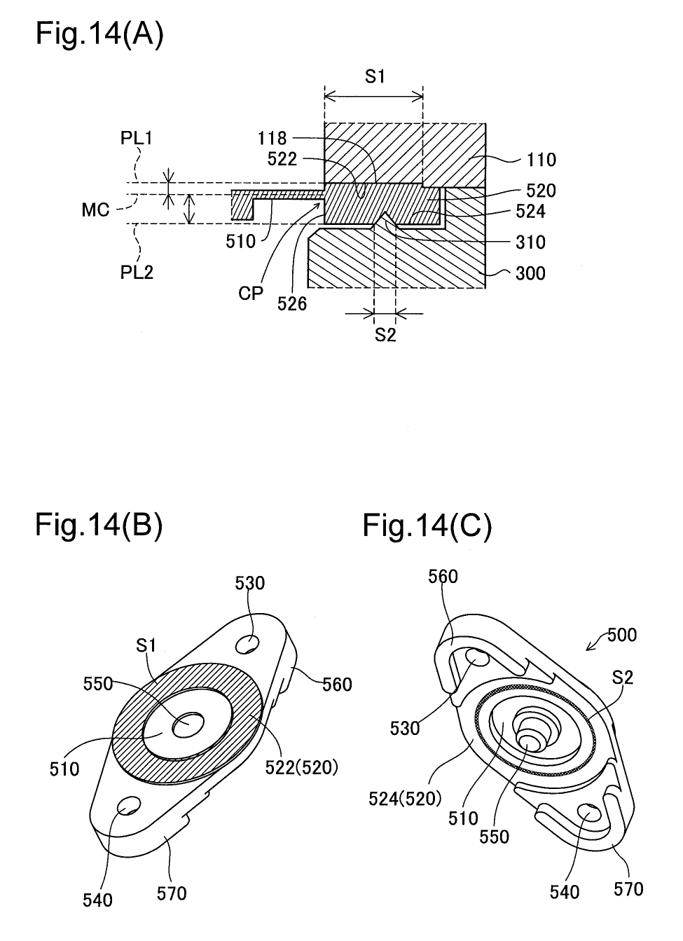

FIG. 14 (A) shows the vicinity of the seal portion 520 of the same cross section diagram as FIG. 7. As described above, the seal portion 520 is gripped between the main body 110 and the spring seat member 300. The seal portion 520 includes the upstream seal surface 522, the downstream seal surface 524, and the side surface 526. The upstream seal surface 522 is the surface in contact with the main body 110. The downstream seal surface 524 is the surface of the side facing opposite the upstream seal surface 522, and is the surface in contact with the spring seat member 300. The side surface 526 is the surface that intersects with these seal surfaces 522 and 524. With this embodiment, the upstream seal surface 522 is almost parallel with the downstream seal surface 524, and the side surface 526 is almost perpendicular with these seal surfaces 522 and 524. The membrane portion 510 is affixed to the side surface 526. The thickness of the seal portion 520 is thicker than the thickness of the membrane portion 510.

The upstream seal surface 522 is in contact with the seal part 118 of the main body 110. The first contact area S1 shows the part that is in contact with the seal part 118 of the upstream seal surface 522. The downstream seal surface 524 is in contact with the rib 310 of the spring seat member 300. The second contact area S2 shows the part that is in contact with the rib 310 of the downstream seal surface 524. The membrane portion 510 is affixed to the seal portion 520 at the position CP between the plane PL1 containing the upstream seal surface 522 and the plane PL2 containing the downstream seal surface 524 with the seal portion 520. FIGS. 14 (B) and 11 (C) are perspective views of the membrane valve 500, the same as FIGS. 5 (A) and 5 (B). In the drawings, the first contact area S1 and the second contact area S2 are indicated by cross hatching.

As shown in the drawing, the area of the first contact area S1 is larger than the area of the second contact area S2. Therefore, the pressure added to the seal portion 520 from the main body 110 and the spring seat member 300 is bigger than that of the downstream seal surface 524 side compared the upstream seal surface 522. As a result, for the size of the local deformation in the seal portion 520, the part near the downstream seal surface 524 is larger than the part near the upstream seal surface 522. In light of this, with this embodiment, as shown in the drawing, the membrane portion 510 is affixed at a position closer to the upstream seal surface 522 than the downstream seal surface 524. In specific terms, at the contact position CP of the membrane portion 510 and the seal portion 520, the membrane portion 510 thickness direction center MC is closer to the upstream seal surface 522 than the downstream seal surface 524. Therefore, when local deformation (distortion) occurs in the seal portion 520, it is possible to reduce the possibility of deformation of an unintentional shape from occurring with the membrane portion 510. Note that with this embodiment, the upstream seal surface 522 correlates to the “first seal surface” of the modes 29 and 31 described later, and the downstream seal surface 524 correlates to the “second seal surface.”

Note that with this embodiment, the inside of the downstream seal surface 524 (membrane portion 510 side area) is linked to the downstream valve chamber 182, specifically, the valve downstream path 190. Also, the outside of the downstream seal surface 524 (area facing the opposite side of the membrane portion 510) is linked to the valve downstream path 190 via between the main body 110 and the spring seat member 300. In this way, both the inside and the outside of the downstream seal surface 524 are linked to the valve downstream path 190. In other words, as shown in FIG. 14 (A), it is also possible to have the seal at the downstream seal surface 524 not be tight. For example, it is possible to have part of the loop shaped second contact area S2 shown in FIG. 14 (C) be missing. Meanwhile, as shown in FIG. 14 (A), it is preferable to have the seal at the upstream seal surface 522 be tight. For example, it is preferable to not have the first contact area S1 loop be missing.

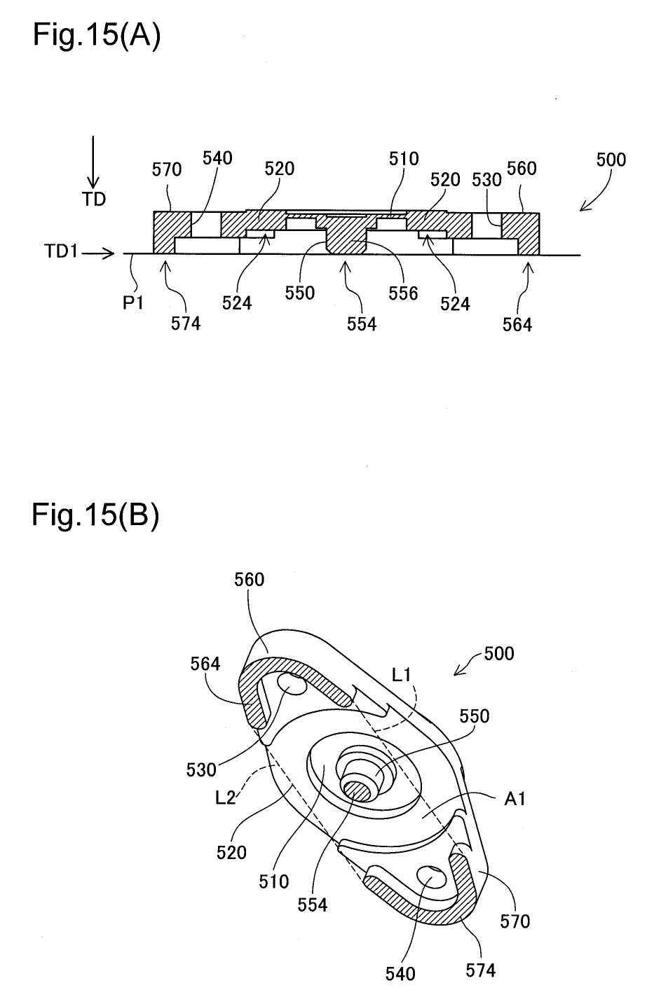

FIG. 15 (A) shows the same cross section diagram as FIG. 6 (B). As shown in FIGS. 6 (A) and 6 (B), the membrane valve 500 is formed in a plate shape. The direction TD in FIG. 15 (A) shows the thickness direction of the membrane valve 500. Here, the projection direction of the projecting portion 556 of the axis portion 550 is the positive direction of the thickness direction TD. The membrane valve 500 is formed in a roughly plate shape expanding in the direction perpendicular to the thickness direction TD. With this embodiment, this thickness direction TD is parallel to the movement directions MD1 and MD2 shown in FIG. 13. The first plane P1 is further shown in FIG. 15 (A). The first plane P1 indicates a table or a flat surface of a member such as a pallet for carrying the membrane valve 500 or the like, for example, and indicates a horizontal surface perpendicular to the gravitational force direction. The cross section of FIG. 15 (A) shows the state with the end of the projecting portion 556 facing the first plane P1, and the membrane valve 500 placed on the first plane P1 from vertically upward. In this state, the end 564 of the first installing portion 560 of the thickness direction TD side and the end 574 of the second installing portion 570 of the thickness direction TD side are in contact with the first plane P1, and they support the membrane valve 500. FIG. 15 (B) is a perspective view that is the same as FIG. 5 (B). With FIG. 15 (B), hatching is added to the part in contact with the first plane P1 shown in FIG. 15 (A). As shown in the drawing, end 564 and end 574 contact the first plane P1.

As shown in FIG. 6 (B) and FIG. 15 (A), in a state with the membrane portion 510 not deformed, the position (TD1) of the end 554 of the axis portion 550, in the thickness direction TD, is the same as the position (TD1) of the ends 564 and 574 of the installing portions 560 and 570 in the thickness direction TD. Therefore, in the state shown in FIG. 15 (A), without deformation of the membrane portion 510, the end 554 of the axis portion 550 is in contact with the first plane P1. Specifically, by the axis portion 550 being supported by the first plane P1, it is possible to maintain the membrane portion 510 in a state without deformation. Therefore, during the transport or storage of the membrane valve 500, it is possible to reduce the possibility of deformation of the membrane portion 510 by placing the membrane portion 510 on a plane as shown in FIG. 15 (A). As a result, even when the membrane valve 500 is transported or stored for a long time, it is possible to reduce the possibility of the membrane portion 510 being deformed in an unintentional shape. Also, because the ends 564 and 574 are in contact with the first plane P1, it is possible to reduce the possibility of position skew of the membrane valve 500 on the first plane P1 (for example, it is possible to reduce the possibility of position skew of the membrane valve 500 on the first plane P1 during transport of the membrane valve 500).

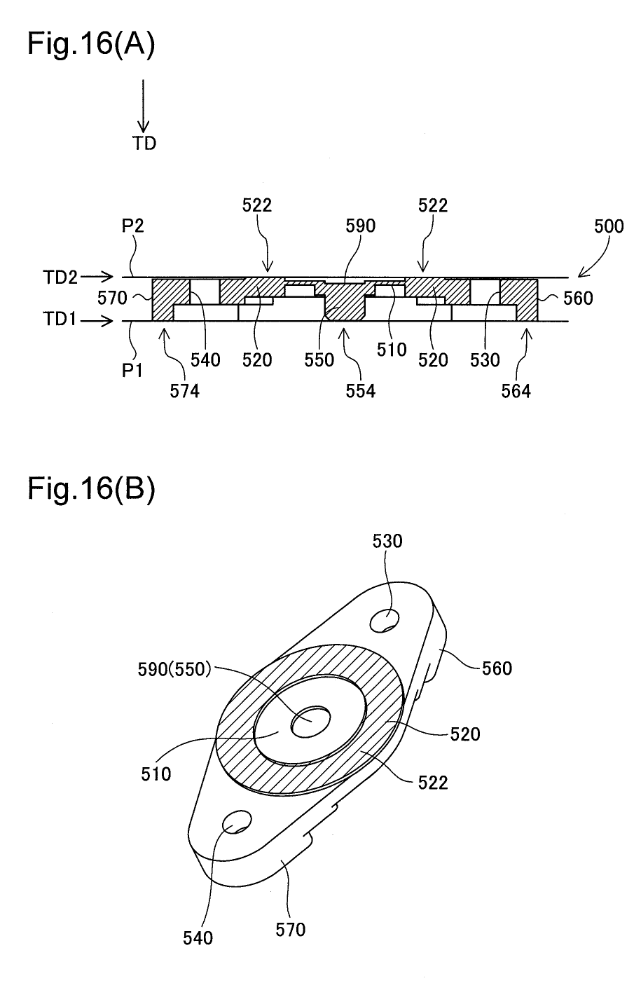

FIG. 16 (A) shows the same cross section diagram as FIG. 6 (B). The difference from FIG. 15 (A) is only that the second plane P2 is shown on the side facing opposite the first plane P1 of the membrane valve 500. The second plane P2 is a plane defined by the highest part of the seal portion 520 (upstream seal surface 522) (following, the upstream seal surface 522 is also called “end 522”). For example, when a flat surface of a member such as a pallet or the like for carrying the membrane valve 500 is placed on the membrane valve 500, that member is supported by the end 522. The second plane P2 correlates to the surface of the member in this state. FIG. 16 (B) is the same perspective view as FIG. 5 (A). With FIG. 16 (B), hatching is applied to the part in contact with the second plane P2 in the state shown in FIG. 16 (A). As shown in the drawing, the end 522 is in contact with the second plane P2.

As shown in FIG. 6 (B) and FIG. 16 (A), in a state with the membrane portion not deformed, the entire membrane portion 510 and the entire contact area 590 are respectively sunk in further than the end 522 (specifically, arranged at a position lower than the second plane P2). In specific terms, the position (TD2) of the end 522 of the seal portion 520, in the thickness direction TD, projects in the reverse direction of the thickness direction TD more than either the membrane portion 510 or the contact area 590. Therefore, it is possible to prevent the membrane portion 510 or the contact area 590 from contacting the second plane P2. As a result, when a pallet or the like is overlapped on the membrane valve 500, it is possible to reduce the possibility of deformation or damage of the membrane portion 510 or the contact area 590. Specifically, it is possible to overlap a pallet or the like on the membrane valve 500 during transport or storage of the membrane valve 500.

Note that as shown in FIGS. 15 (A) and 15 (B), the shapes of the ends 564 and 574 of the installing portions 560 and 570 are respectively U shapes arranged on the same plane. Therefore, one plane (first plane P1) is defined by these ends 564 and 574. Also, these ends 564 and 574 are arranged so as to face sandwiching the end 554 of the axis portion 550. Specifically, the end 554 of the axis portion 550 is surrounded by these ends 564 and 574. Therefore, it is possible for these ends 564 and 574 to support the first plane P1 without placing an excessive load on the axis portion 550. Note that the entirety of the installing portions 560 and 570 correlate to the “first support portion” in modes 33 and 38 described later.

Also, as shown in FIG. 16 (B), the shape of the end 522 of the seal portion 520 is a round shape. Therefore, one plane (second plane P2) is defined by this end 522. Note that the seal portion 520 correlates to the “second support portion” in modes 35 and 40 described later.

The detailed constitution of the first embodiment and the modified embodiments described above can be applied in the same way to the second and fourth embodiments as well. Also, except for the constitution relating to the coil spring, they can be applied to the third embodiment as well.

### F. Sixth Embodiment

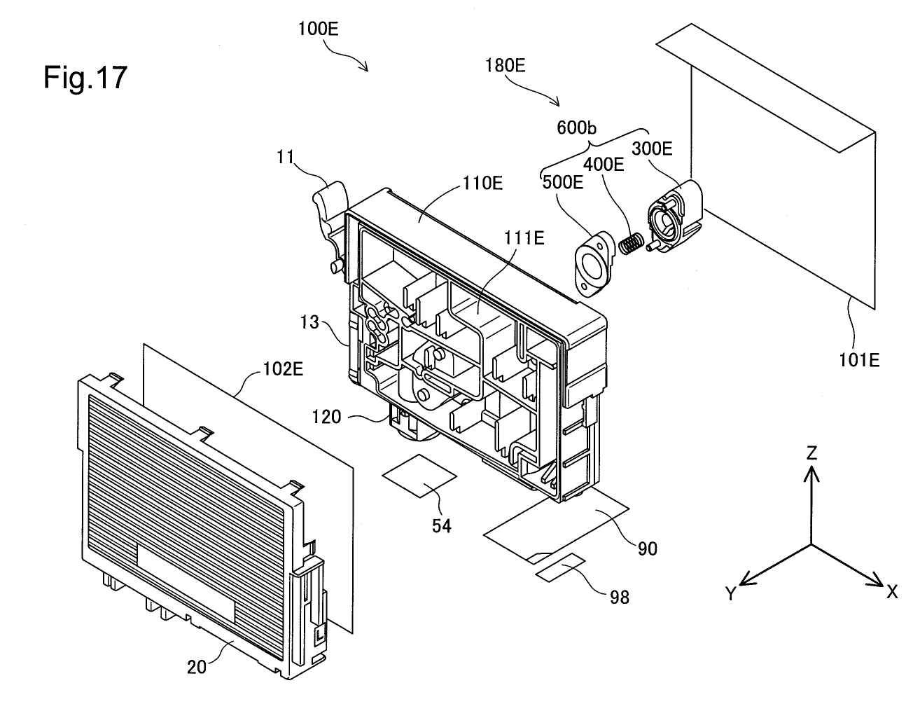

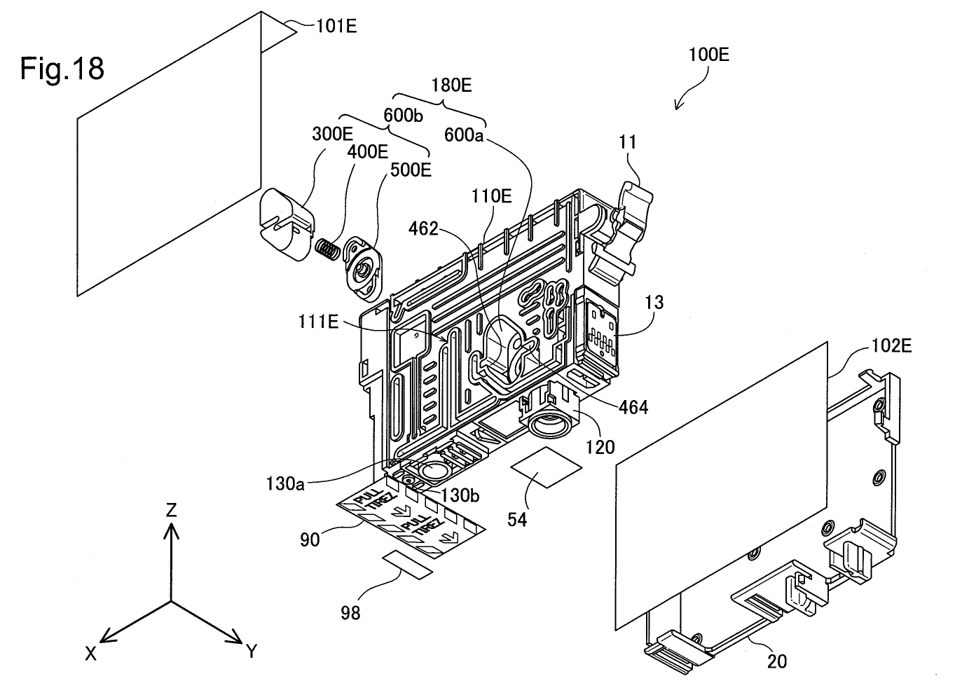

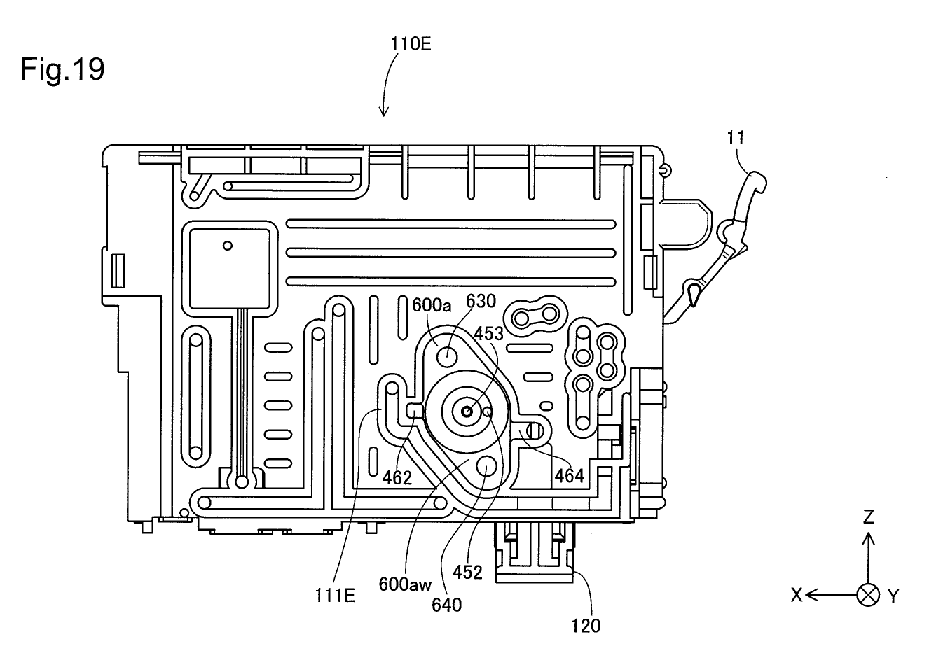

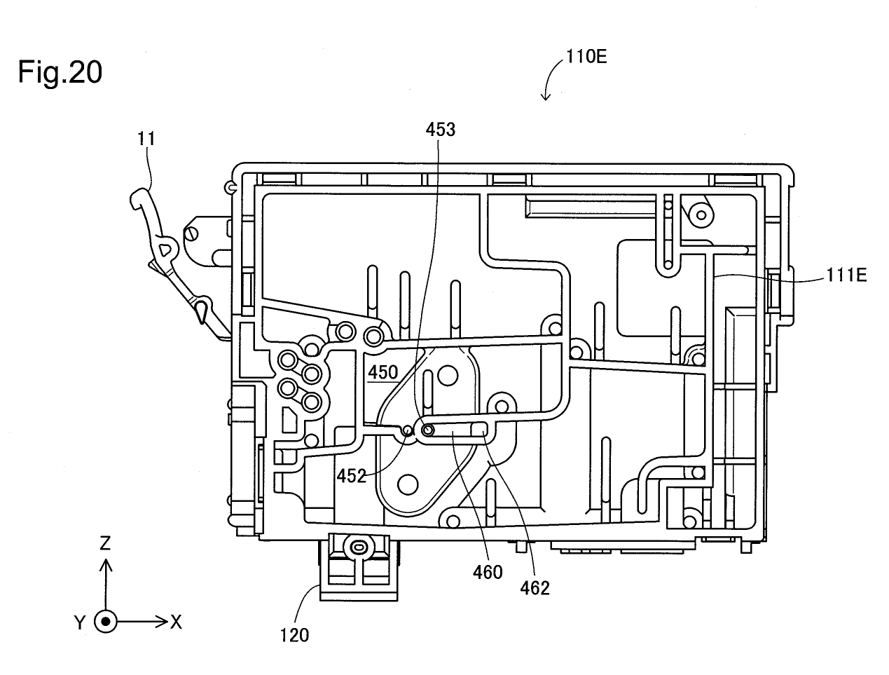

FIG. 17 and FIG. 18 are exploded perspective views showing the constitution of the ink cartridge 100E for the sixth embodiment. FIG. 19 is a side view of one side of the main body 110E, and FIG. 20 is a side view of the other side of the main body 110E. The main difference from the ink cartridge 100 of the first embodiment is that, in the valve section 180E, the membrane valve 500E is arranged so as to be roughly parallel in relation to the gravitational force direction. The detailed constitution of the ink flow path is different between the first embodiment and this embodiment, but the overview of the path that reaches from the air opening hole to the liquid supply section of this embodiment is the same as in FIG. 3 (the valve section 180 in FIG. 3 is to be replaced by the valve section 180E of this embodiment). Also, the axes X, Y, and Z in the drawing are orthogonal to each other. The X axis is the front-back direction of the ink cartridge 100E, the Y axis is the left-right direction, and the Z axis is the up-down direction. The Z axis matches the gravitational force direction. The +Z direction shows the upward direction of the gravitational force direction. The X direction shows the direction from the front surface toward the back surface of the ink cartridge 100E. The Y direction shows the direction from the first side surface toward the second side surface of the ink cartridge 100E. Note that with FIG. 17 to FIG. 27 referred to with the description of this embodiment, the same code numbers are allocated to the elements that are the same as the elements of the first embodiment and the fifth embodiment. Following, a detailed description relating to the elements that are the same as the elements of the first embodiment and the fifth embodiment will be omitted.

As shown in FIG. 17 and FIG. 18, the ink cartridge 100E of this embodiment has the main body 110E, the first side film 101E and the second side film 102E that sandwich the main body 110E, a lid member 20 installed from outside the second side film 102E to the main body 110E, and sealing films 54, 90, and 98.

Provided on the bottom surface of the main body 110E are the ink supply section 120, the air opening hole 130a, and a pressure reduction hole 130b. These elements 120, 130a, and 130b are respectively sealed by the sealing films 54, 90, and 98. Note that the pressure reduction hole 130b is used to reduce pressure within the ink cartridge 100E by suctioning out the air when injecting ink in the ink cartridge 100E manufacturing process.

An engaging lever 11 is provided at the front surface of the main body 110E. The circuit board 13 is provided at the bottom of the engaging lever 11 of the front surface of the main body 110E. Various shaped ribs 111E are formed at both side surfaces of the main body 110E. The side films 101E and 102E are adhered to the main body 110E so as to cover the entire both side surfaces of the main body 110E. The side films 101E and 102E are closely adhered so that no gap is produced between the end surface of the rib 111E and the side films 101E and 102E. By doing this, various flow paths and various chambers are formed inside the main body 110E. For example, the serpentine path 130 of FIG. 3, an ink storage chamber 140, an intermediate flow path 150, a buffer chamber 160, a valve upstream path 170, and a valve downstream path 190 are formed. The detailed shapes of these flow paths and chambers can be different shapes from the first embodiment, but since there is no big difference in the function, a detailed description is omitted.

As shown in FIG. 18, a valve storage chamber 600a is formed on one side surface of the main body 110E. The valve storage chamber 600a is a concave portion that is sagging from one side surface to the other side surface of the main body 110E. FIG. 19 shows the bottom wall of the valve storage chamber 600a (the +Y direction wall, also called the “valve wall 600aw”). Openings 452 and 453 are provided on the valve wall 600aw. As shown in FIG. 20, these openings 452 and 453 are respectively linked to the flow paths 450 and 460 formed on the other side surface of the main body 110E.

As shown in FIG. 18, the valve assembly 600b obtained by combining the spring seat member 300E, the coil spring 400E, and the membrane valve 500E is fit into the valve storage chamber 600a. The entirety of the valve storage chamber 600a and the valve assembly 600b correlate to the valve section 180E.

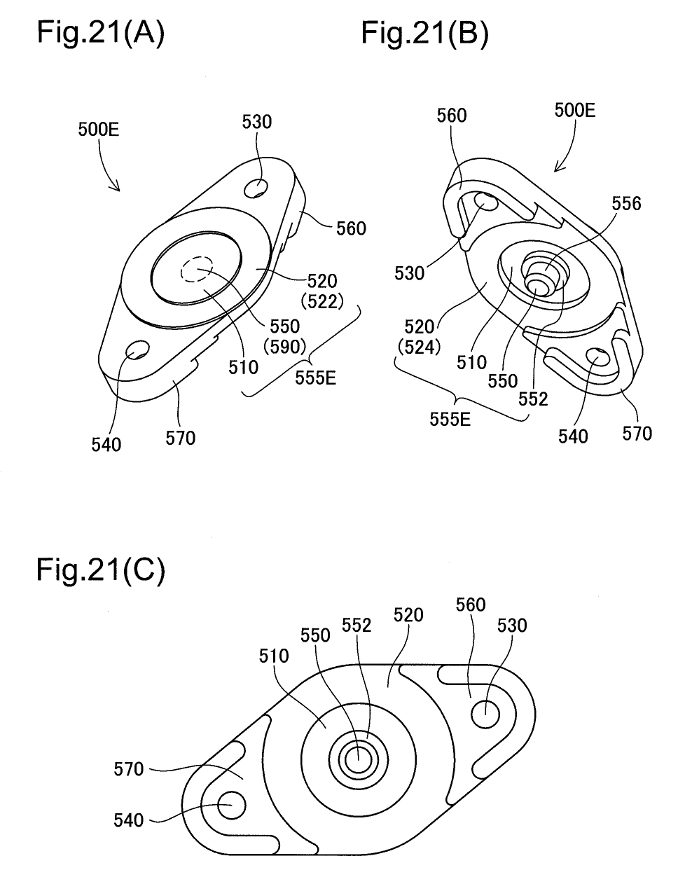

FIG. 21 are explanatory drawings of the membrane valve 500E. FIGS. 21 (A) and 21 (B) show the same perspective view as FIGS. 5 (A) and 5 (B), and FIG. 21 (C) is a front view of the membrane valve 500E seen from the projecting portion 556 side. The difference from the membrane valve 500 shown in FIG. 5 is that the contact area 590 is not concave from the membrane portion 510 with the valve main portion 555E. The remaining constitution of the membrane valve 500E is the same as the membrane valve 500 of the first and fifth embodiments. In this way, the membrane valve 500E is also formed in roughly a plate shape. Also, by using this membrane valve 500E, it is possible to obtain the same various advantages as when using the membrane valve 500 of the first and fifth embodiments.

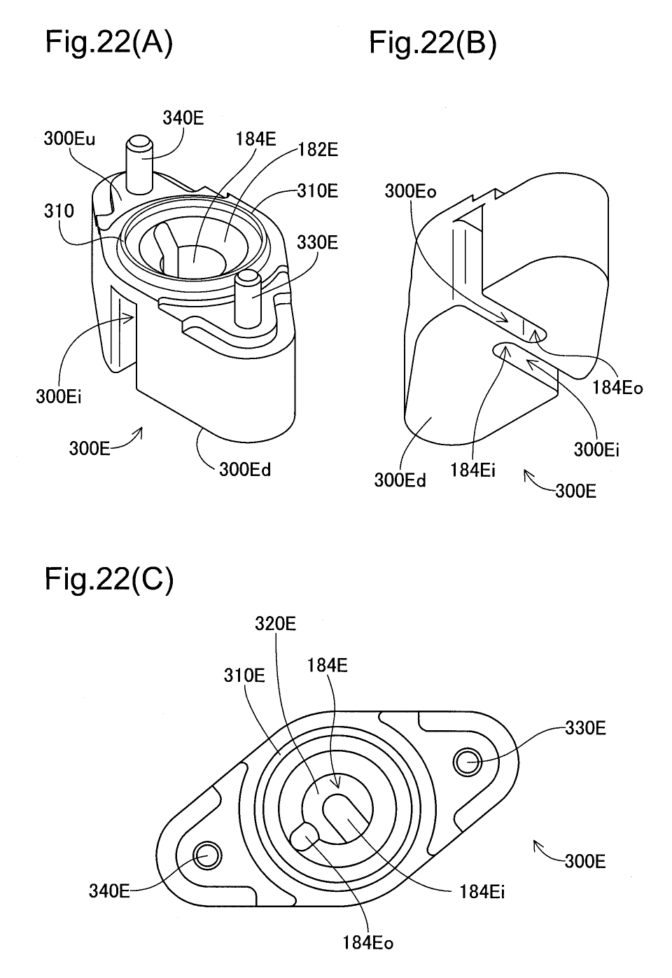

FIGS. 22 (A) and 22 (B) are perspective views of the spring seat member 300E. FIG. 22 (C) is a front view of the first surface 300Eu of the spring seat member 300E on which the membrane valve 500E is installed. The spring seat member 300E is a roughly column shaped member that extends from the second surface 300Ed to the first surface 300Eu. The membrane valve 500E (FIG. 21) is installed in the first surface 300Eu. The axes 330E and 340E and the loop shaped rib 310 are formed on the first surface 300Eu. The downstream valve chamber 182E and the spring accommodating chamber 184E are formed in the area surrounded by the rib 310. The inflow path 300Ei and the outflow path 300Eo are formed on the second surface 300Ed. These flow paths 300Ei and 300Eo are flow paths in a groove shape that reach from the side surface to the interior of the spring seat member 300E. Note that the spring accommodating chamber 184E correlates to the “concave portion that receives the end of the coil spring 400E.”

As shown in FIG. 22 (C), the inflow hole 184Ei is formed on the bottom of the spring accommodating chamber 184E, and the outflow hole 184Eo is formed on the side surface of the spring accommodating chamber 184E. As shown in FIG. 22 (B), the inflow hole 184Ei is linked to the inflow path 300Ei, and the outflow hole 184Eo is linked to the outflow path 300Eo.

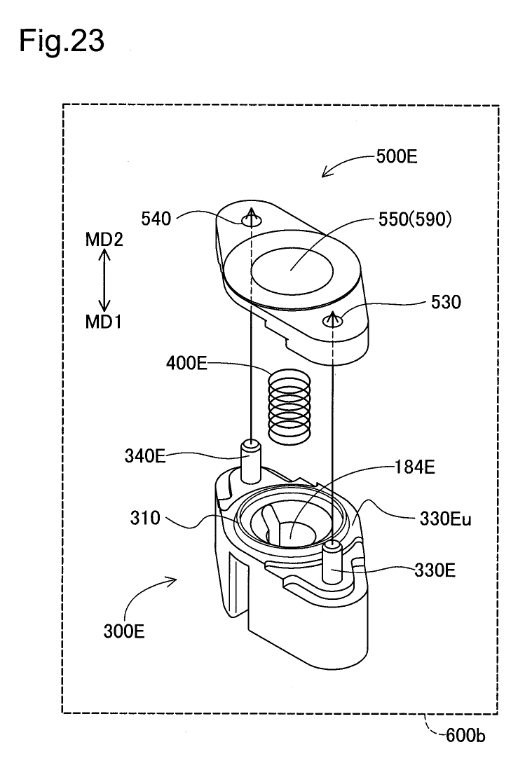

FIG. 23 is an exploded perspective view of the valve assembly 600b. The coil spring 400E is inserted in the spring accommodating chamber 184E. In this state, the membrane valve 500E is installed on the first surface 300Eu of the spring seat member 300E. The axes 330E and 340E of the spring seat member 300E are respectively inserted in the holes 530 and 540 of the membrane valve 500E. The installation state is the same as the state shown in FIG. 12 (B).

The valve assembly 600b is fit in the valve storage chamber 600a (FIG. 18). At this time, the first surface 300Eu of the spring seat member 300E faces the valve wall 600aw of the valve storage chamber 600a. As shown in FIG. 19, two concave portions 630 and 640 are provided on the valve wall 600aw. In a state with the valve assembly 600b fit in the valve storage chamber 600a, the end of the axis 330E is inserted in the concave portion 630, and the end of the axis 340E is inserted in the concave portion 640. By doing this, it is possible to reduce the possibility of position skew of the axes 330E and 340E. Also, the membrane valve 500E is sandwiched by the first surface 300Eu of the spring seat member 300E and the valve wall 600aw of the valve storage chamber 600a.

With this embodiment, the contour of the spring seat member 300E of the cross section parallel to the membrane valve 500E is almost the same as the contour of the membrane valve 500E (FIG. 21 (C), FIG. 22 (C)). Specifically, the overall shape of the valve assembly 600b is roughly a column shape having a specified cross section shape. Also, the shape of the valve storage chamber 600a that stores the valve assembly 600b is also a roughly column shape having a cross section shape with almost the same cross section shape. In this way, simple column shapes are used as the respective outer shapes of the valve storage chamber 600a and the valve assembly 600b. Therefore, it is possible to use a simple constitution for the valve section 180E. Also, ink flow paths (flow paths 300Ei and 300Eo) are formed inside the spring seat member 300E, so it is possible to make the valve section 180E compact.

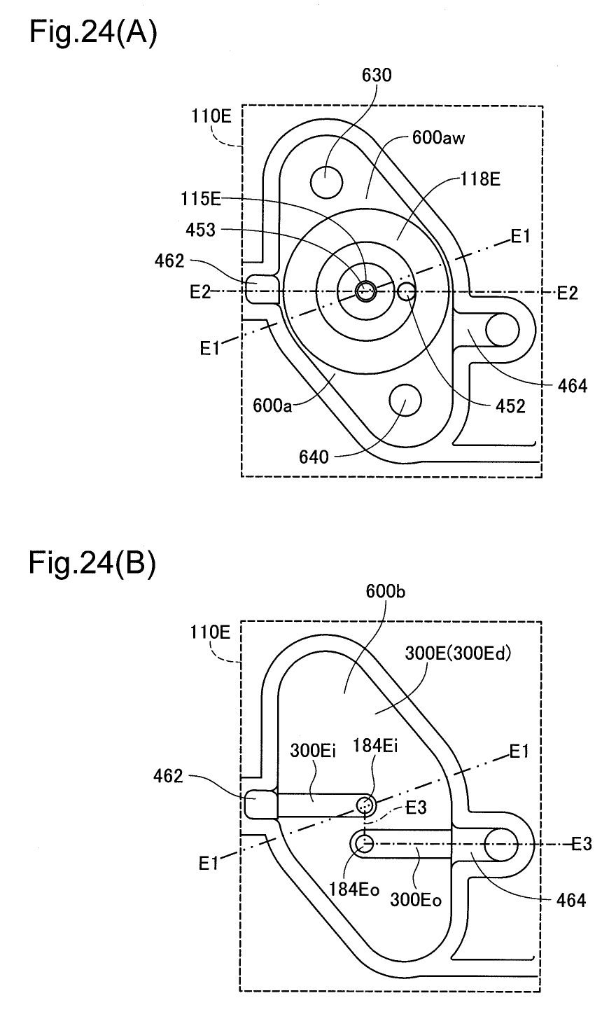

FIG. 24 is an enlarged view of the side view shown in FIG. 19 of the part including the valve storage chamber 600a. FIG. 24 (A) shows before installation of the valve assembly 600b, and FIG. 24 (B) shows after installation of the valve assembly 600b. The first flow path 462 provided in the main body 110E is a flow path that is orthogonal to the side surface of the main body 110E, and links one side and the other side of the main body 110E. As shown in FIG. 18, this first flow path 462 contains a groove formed on the inner wall of the valve storage chamber 600a. The second flow path 464 provided on the main body 110E is a flow path that extends in parallel from the inner wall of the valve storage chamber 600a to the side surface of the main body 110E. As shown in FIG. 19, the second flow path 464 and the ink supply section 120 are linked. As shown in FIG. 24 (B), the inflow path 300Ei of the spring seat member 300E is linked to the first flow path 462. Also, the outflow path 300Eo is linked to the second flow path 464.

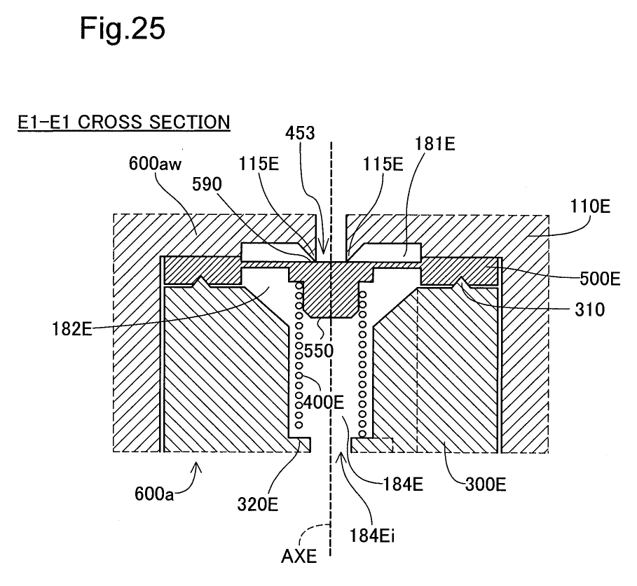

FIG. 25 is the E1-E1 cross section diagram of the valve section 180E. As shown in FIGS. 24 (A) and 24 (B), this cross section goes through the center axis of the opening 453 formed by the apex shape 115E (same as the axis AXE in FIG. 25), and does not go through the opening 452 and outflow hole 184Eo. FIG. 25 shows the closed valve state. The upstream valve chamber 181E is formed between the valve wall 600aw and the membrane valve 500E. By having the contact area 590 contact the apex shape 115E, the opening 453 is closed. The downstream valve chamber 182E and the spring accommodating chamber 184E are formed between the membrane valve 500E and the spring seat member 300E. The shape of the downstream valve chamber 182E has a tapered shape that is deeper the closer it goes toward the center axis AXE, and becomes shallower the more it goes away from the center axis AXE. The spring accommodating chamber 184E has a round cylinder shape. One end of the spring accommodating chamber 184E is linked to the downstream valve chamber 182E, and on the other end of the spring accommodating chamber 184E is formed the spring supporting portion 320E that supports the coil spring 400E. Also, at the other end of the spring accommodating chamber 184E is formed the inflow hole 184Ei. The opening 453, the axis portion 550, the downstream valve chamber 182E, and the spring accommodating chamber 184E are arranged on the same axis (the center axis AXE indicates the center axis common to each element).

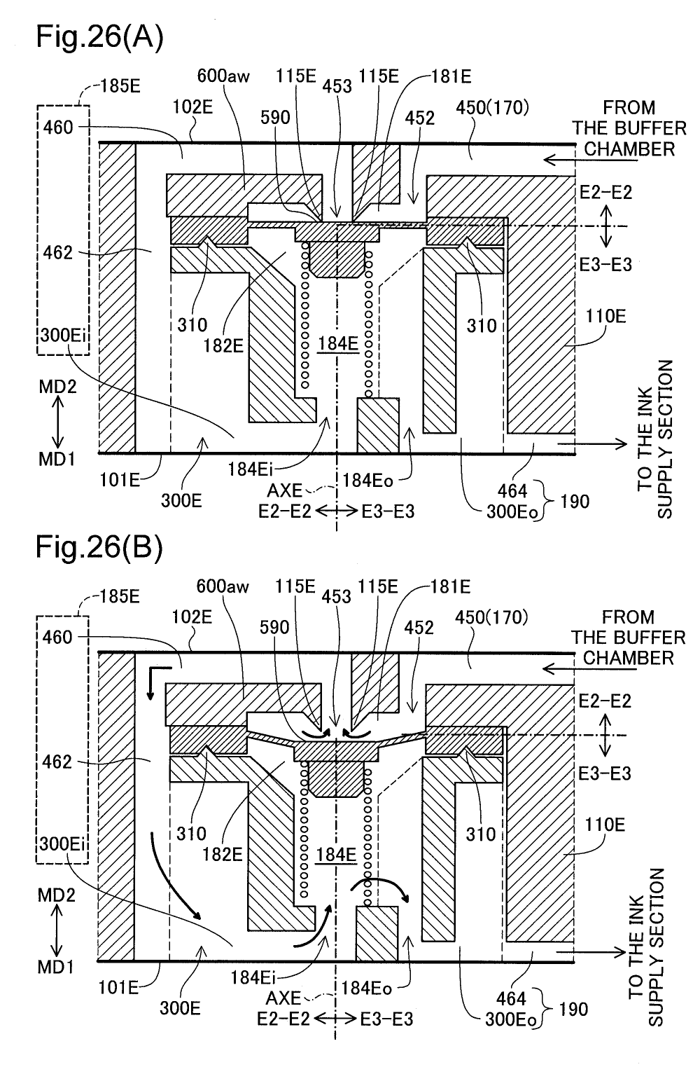

FIGS. 26 (A) to 26 (B) are other schematic cross section diagrams of the valve section 180E. These cross section diagrams are a synthesis of the E2-E2 cross section and the E3-E3 cross section (FIGS. 24 (A) and 24 (B)). The part at the bottom right of FIGS. 26 (A) and 26 (B) is the E3-E3 cross section, and the remaining part is the E2-E2 cross section. As shown in FIGS. 24 (A) and 24 (B), the E2-E2 cross section is a cross section that goes through the first flow path 462, the opening 453 center axis AXE, and the opening 452. The E3-E3 cross section is a cross section that goes from the center axis AXE through the outflow hole 184Eo, changes direction at the outflow hole 184Eo, and goes through the outflow path 300Eo, and reaches the second flow path 464. In the drawing, the E3-E3 cross section shows the details of the spring seat member 300E and the main body 110E. Note that regarding the part of the E3-E3 cross section in the drawing that goes through the second flow path 464, the scale of the perpendicular direction in relation to the center axis AXE is adjusted so that the distance from the center axis AXE matches the E2-E2 cross section.

FIG. 26 (A) shows the closed valve state. The opening 452 of the valve wall 600aw is linked to the buffer chamber 160 (FIG. 3) via the flow path 450. The opening 453 of the center of the valve wall 600aw is closed by the contact area 590. The opening 453 is linked to the inflow hole 184Ei of the spring accommodating chamber 184E via the flow path 460, the first flow path 462, and the inflow path 300Ei. The outflow hole 184Eo of the spring accommodating chamber 184E is linked to the second flow path 464 via the outflow path 300Eo. The second flow path 464 is linked to the ink supply section 120 (FIG. 3). Note that the flow path 450 correlates to the valve upstream path 170 of FIG. 3. Also, the entirety of the outflow path 300Eo and the second flow path 464 correlate to the valve downstream path 190 of FIG. 3. Also, the entirety of the flow path that reaches from the opening 453 to the inflow hole 184Ei is also called the “relay flow path 185E” (flow path 460, first flow path 462, and inflow path 300Ei).

FIG. 26 (B) shows the open valve state. The valve opening and closing mechanism is the same as the first embodiment. By consumption of the ink, the pressure of the valve downstream path 190, specifically the downstream valve chamber 182E (fluid pressure) drops. When the difference in the pressure in the upstream valve chamber 181E in relation to the pressure in the downstream valve chamber 182E (differential pressure) exceeds a specified pressure, the membrane portion 510 is deformed and the axis portion 550 moves in the first movement direction MD1. As a result, a gap is formed between the apex shape 115E and the contact area 590, and the valve upstream path 170 is linked to the valve downstream path 190 via the relay flow path 185E and the spring accommodating chamber 184E. In this state, the ink flows into the valve downstream path 190 via the relay flow path 185E from the valve upstream path 170. By this inflow of ink, the pressure in the valve downstream path 190 rises, the differential pressure goes to the specified pressure or below, and the membrane valve 500E returns to the closed valve state.

Note that with this embodiment, the axes 330E and 340E shown in FIG. 23 respectively correlate to the “engaging axis.” These axes 330E and 340E can be constituted in the same way as the axes 330 and 340 in FIG. 12. Specifically, it is acceptable as long as the side surface of the axis 330E is in contact with at least part of the inner surface of the hole 530. The same is also true for the combination of the hole 540 and the axis 340E. By doing this, it is possible to reduce the possibility of position skew of the membrane valve 500.

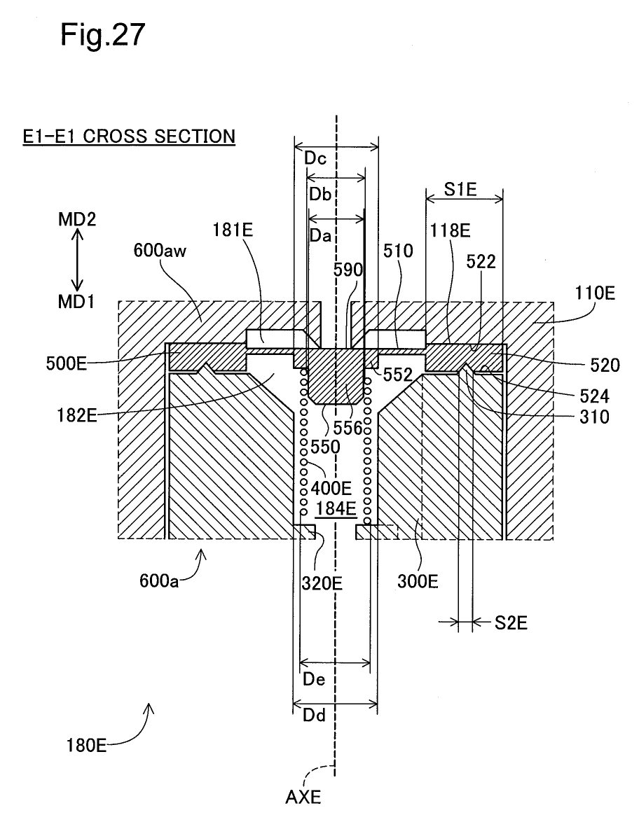

FIG. 27 are the same cross section diagram as FIG. 25. The same dimensions Da to De as in FIG. 13 are shown in FIG. 27. With this embodiment, Da to De are set the same as with the fifth embodiment, and it is possible to obtain the same effect as those described with the fifth embodiment.

Also, with this embodiment, the upstream seal surface 522 of the seal portion 520 is in contact with the seal part 118E of the main body 110E, and the downstream seal surface 524 of the seal portion 520 is in contact with the rib 310 of the spring seat member 300E. The first contact area S1E in the drawing shows the part of the upstream seal surface 522 in contact with the seal part 118E, and the second contact area S2E shows the part of the downstream seal surface 524 in contact with the rib 310. The same as with the fifth embodiment, the area of the first contact area S1E is wider than the area of the second contact area S2E, and the membrane portion 510 is affixed at a position closer to the upstream seal surface 522 than the downstream seal surface 524. Therefore, the same as with the fifth embodiment, it is possible to reduce the possibility of the membrane portion 510 deforming in an unintentional shape due to local deformation (distortion) in the seal portion 520. Note that the same as with the fifth embodiment, with this embodiment, the seal made by the downstream seal surface 524 and the rib 310 does not have to be tight.

Also, as described above, the difference between the membrane valve 500E of this embodiment and the membrane valve 500 of the first and fifth embodiments is only that, in the membrane valve 500E, the contact area 590 is more indented than the membrane portion 510. Therefore, by placing the membrane valve 500E on the first plane P1, it is possible to maintain a state of the membrane portion 510 not deformed, just like the membrane valve 500 of the first and fifth embodiments. Also, when the membrane 500E is placed on the second plane P2, it is possible to prevent contact by the membrane portion 510 or the contact area 590 on the second plane P2, just like membrane valve 500 of the first and fifth embodiments.

The constitution of the valve section 180E of the sixth embodiment described above can be mutually replaced by the respective valve section constitutions of the first to fifth embodiments. For example, it is also possible to use the constitution of the valve section 180E of the sixth embodiment for the ink cartridge 100 of the first embodiment with the membrane valve arranged so as to be horizontal (perpendicular to the gravitational force direction). It is also possible to use the constitution of the valve section of the first to fifth embodiments for the ink cartridge 100E of the sixth embodiment with the membrane valve arranged so as to be perpendicular (parallel in relation to the gravitational force direction).

### G. Seventh Embodiment

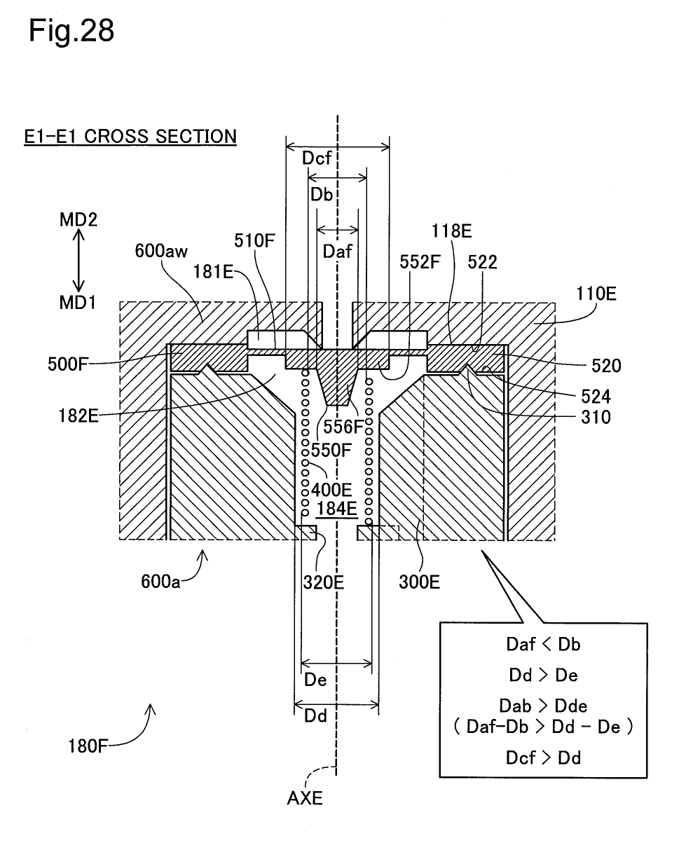

FIG. 28 is an explanatory drawing showing the constitution of the valve section 180F of the seventh embodiment. The difference from the valve section 180E shown in FIG. 27 is only that the membrane valve 500E is replaced by the membrane valve 500F. The remainder of the constitution is the same as that of the sixth embodiment. There are two differences between the membrane valve 500F of this embodiment and the membrane valve 500E of the sixth embodiment. One difference is that the shape of the axis portion 550F (projecting portion 556F) is a taper shape. The second difference is that the outer diameter Dcf of the spring receiving portion 552F is larger than the outer diameter Dc of the spring receiving portion 552. The remainder of the constitution of the membrane valve 500F is the same as that of the membrane valve 500E of the sixth embodiment. Therefore, the valve section 180F of this embodiment has the same various advantages as the valve section 180E of the sixth embodiment. Also, the membrane portion 510F, the spring receiving portion 552F, the projecting portion 556F, and the spring accommodating chamber 184E are arranged on the same axis. Also, the shape of the cross section perpendicular to the center axis AXE of these members 510F, 552F, and 556F is roughly circular. Also, the shape of the cross section perpendicular to the center axis AXE of the inside wall of the spring accommodating chamber 184E is roughly circular.

With this embodiment, the outer diameter of the projecting portion 556F of the axis portion 550F is smaller the closer it gets to the tip. Therefore, it is easy to insert the end of the projecting portion 556F inside the end of the coil spring 400E.

The maximum outer diameter Daf of the projecting portion 556F is smaller than the inner diameter Db of the coil spring 400E (“Daf-Db” is called the “first difference Dab”). The inner diameter Dd of the spring accommodating chamber 184E is larger than the outer diameter De of the coil spring 400E (“Dd-De” is called the “second difference Dde”). Also, the first difference Dab is larger than the second difference Dde. Therefore, when the coil spring 400E moves in a direction perpendicular to the movement directions MD1 and MD2 inside the spring accommodating chamber 184E, it is possible to reduce the possibility of the coil spring 400E contacting the projecting portion 556F. When the material of the membrane valve 500F is a flexible material, there are cases when the material has adhesiveness. Here, when the coil spring 400E contacts the projecting portion 556F, it is possible that the coil spring 400E will not separate from the projecting portion 556F. Unintended adherence of the coil spring 400E and the projecting portion 556F has adverse effects respectively on the suitable deformation of the membrane valve 500F and on the suitable expansion and contraction of the coil spring 400E. With the constitution in FIG. 28, it is possible to reduce the possibility of unintentional adhesion. Therefore, it is possible to stabilize the operation of the membrane valve 500F.

Also, around the projecting portion 556F, the spring receiving portion 552F is formed surrounding the periphery of the projecting portion 556F. The periphery of the spring receiving portion 552F is affixed to the membrane portion 510F. The thickness of the spring receiving portion 552F is thicker than the thickness of the membrane portion 510F. Also, this spring receiving portion 552F receives one end of the coil spring 400E. Therefore, it is possible to reduce the possibility of damage to the membrane valve 500F by the coil spring 400E.

Also, the outer diameter Dcf of the spring receiving portion 552 is larger than the inner diameter Dd of the spring accommodating chamber 184E. Therefore, when the position of the coil spring 400E is skewed within the spring accommodating chamber 184E, it is possible to reduce the possibility of the end part of the coil spring 400E falling out of the spring receiving portion 552F.

Note that the shape of the axis portion 550F of the membrane valve 500F of this embodiment can also be a round column shape like the first, second, fifth, and sixth embodiments. Also, with the first to sixth embodiments, it is also possible to have the shape of the axis portion of the membrane valve be a taper shape like that of this embodiment. Furthermore, with the first, second, fourth, and fifth embodiments, if the first difference Dab is made larger than the second difference Dde as with this embodiment, it is possible to obtain the same effects as this embodiment. Also, the constitution of the valve section 180F of this embodiment can be applied not only to the ink cartridge 100E of the sixth embodiment, but also to the ink cartridge 100 of the first embodiment.

### H. Eighth Embodiment

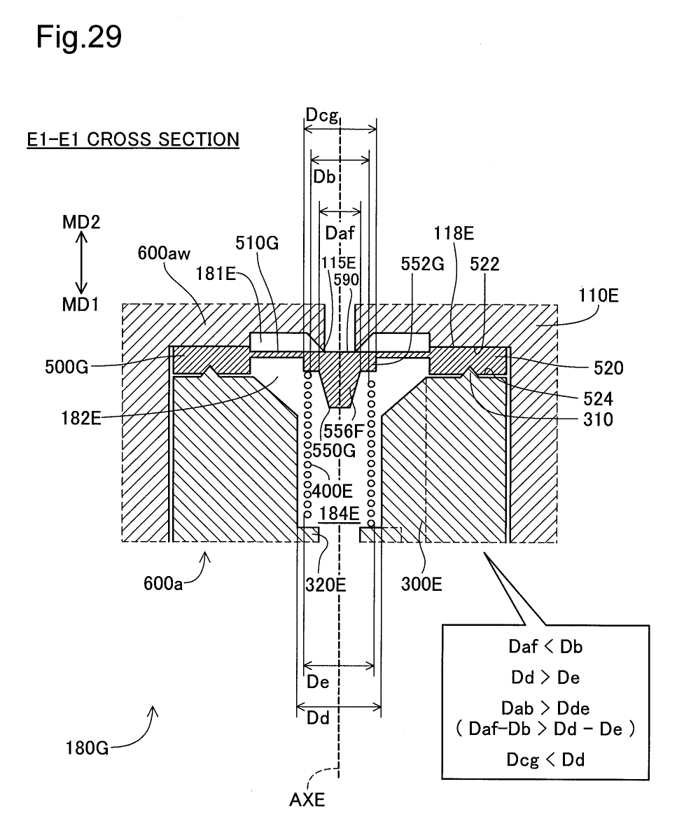

FIG. 29 is an explanatory drawing showing the constitution of the valve section 180G of the eighth embodiment. The difference from the valve section 180F of the seventh embodiment is only that the outer diameter Dcg of the spring receiving portion 552G is smaller than the inner diameter Dd of the spring accommodating chamber 184E. The remainder of the constitution is the same as the valve section 180F of the seventh embodiment. Therefore, the valve section 180G of this embodiment has the same various advantages as the valve section 180F of the seventh embodiment. Also, the outer diameter Dcg of the spring receiving portion 552G is smaller than the inner diameter of the spring accommodating chamber 184E. Therefore, when the contact area 590 separates from the apex shape 115E (specifically, when the spring receiving portion 552G moves toward the spring accommodating chamber 184E), it is possible to reduce the possibility of the spring receiving portion 552G contacting the wall of the downstream valve chamber 182E or the wall of the spring accommodating chamber 184E. As a result, when the material of the membrane valve 500G has adhesiveness, it is possible to reduce the possibility of the spring receiving portion 552G adhering to the wall described above.

Note that the shape of the axis portion 550G of the membrane valve 500G of this embodiment can also be a round column shape like that of the first, second, fifth, and sixth embodiments. Also, with the first through sixth embodiments, the shape of the axis portion of the membrane valve can also be a taper shape like that of this embodiment. Furthermore, with the first, second, fourth, and fifth embodiments, if the outer diameter Dcg of the spring receiving portion 552G is made smaller than the inner diameter Dd of the spring accommodating chamber 184E as with this embodiment, it is possible to obtain the same effects as this embodiment. Also, the constitution of the valve section 180G of this embodiment can be applied not only to the ink cartridge 100E of the sixth embodiment, but also to the ink cartridge 100 of the first embodiment.

### I. Ninth Embodiment

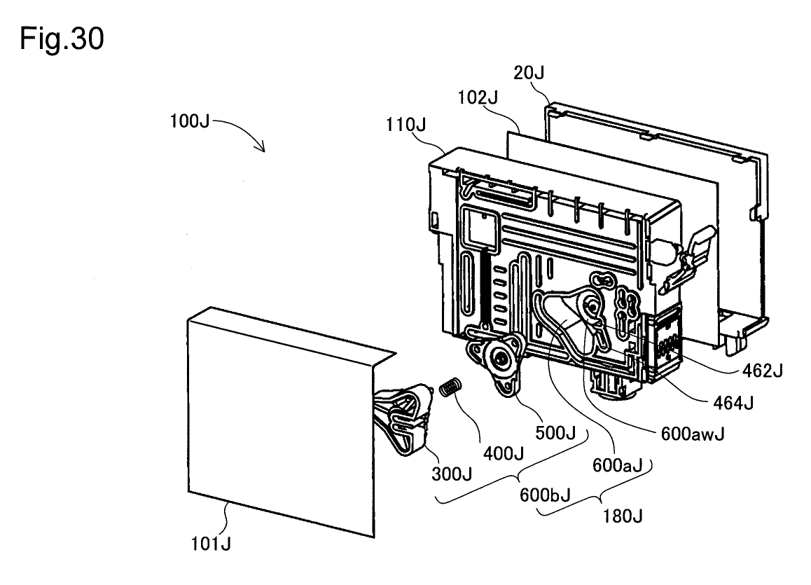

FIG. 30 is an exploded perspective view showing the constitution of the ink cartridge 100J of the ninth embodiment. The main difference from the ink cartridge 100E of the sixth embodiment is that the shape of the valve section 180J is different (details will be described later). The remainder of the constitution is the same as the ink cartridge 100E of the sixth embodiment. The detailed constitution of the ink flow path is different between the sixth embodiment and this embodiment, but the overview of the path from the air opening hole to the liquid supply section with this embodiment is the same as that in FIG. 3 (the valve section 180 of FIG. 3 is replaced with the valve section 180J of this embodiment).

The ink cartridge 100J of this embodiment includes the main body 110J, the first side film 101J and the second side film 102J that sandwich the main body 110J, and the lid member 200J installed in the main body 110J from outside the second side film 102J. The various flow paths and chambers are formed by the rib on both side surfaces of the main body 110J. FIG. 30 shows the valve storage chamber 600aJ, the first flow path 462J, and the second flow path 464J. Though it is omitted in the drawing, a sealing film is adhered to the bottom surface of the main body 110J.

The valve assembly 600bJ obtained by combining the spring seat member 300J, the coil spring 400J, and the membrane valve 500J is fit in the valve storage chamber 600aJ. The valve wall 600awJ is formed on the bottom of the valve storage chamber 600aJ. The membrane valve 500J is sandwiched by the valve wall 600awJ and the spring seat member 300J. The entirety of the valve storage chamber 600aJ and the valve assembly 600bJ correlates to the valve section 180J.

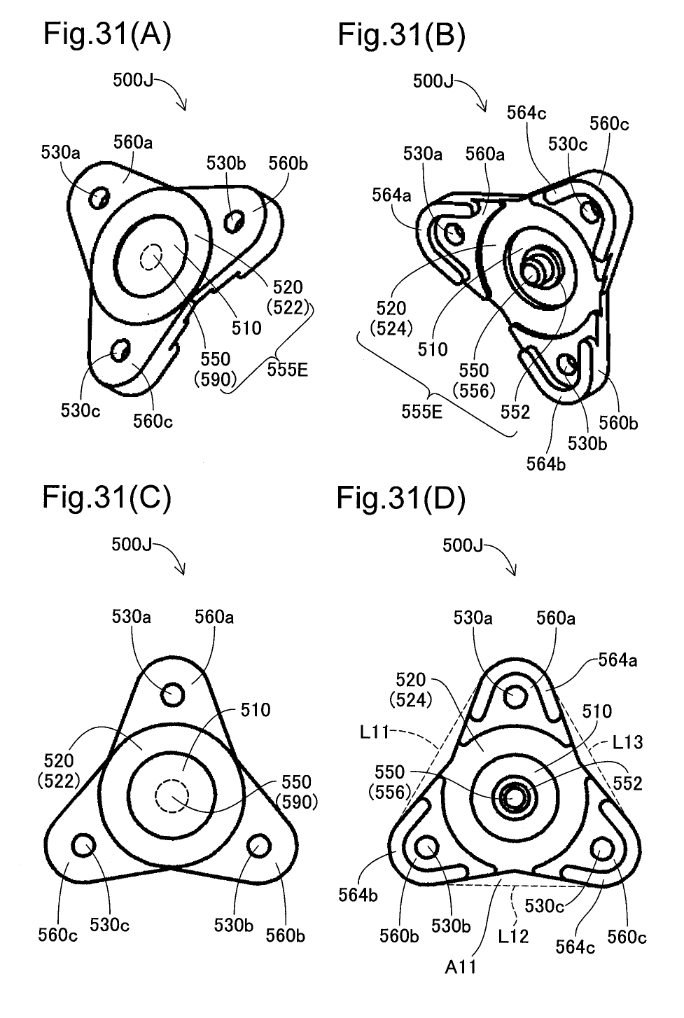

FIG. 31 are explanatory drawings of the membrane valve 500J. FIGS. 31 (A) and 31 (B) show the same perspective view as FIGS. 21 (A) and 21 (B), FIG. 31 (C) shows a front view of the membrane valve 500J seen from the contact area 590 side, and FIG. 31 (D) shows a front view of the membrane valve 500J seen from the projecting portion 556 side. The difference from the membrane valve 500E shown in FIG. 21 is only that the number of installing portions is changed from 2 to 3. The constitution of the valve main portion 555E is the same as the constitution of the valve main portion 555E of FIG. 21. With this embodiment, three installing portions 560a, 560b, and 560c are affixed isotropically to the outer periphery of the valve main portion 555E. The shape of each installing portion 560a, 560b, and 560c is almost the same as that of the installing portion 560 in FIG. 21. Holes 530a, 530b, and 530c are respectively formed on the installing portions 560a, 560b, and 560c. These holes 530a, 530b, and 530c extend along the same direction as the movement direction of the contact area 590. Also, the installing portions 560a, 560b, and 560c respectively have U shaped ends 564a, 564b, and 564c. Also, as shown in the drawing, the membrane valve 500J is formed in a roughly plate shape.

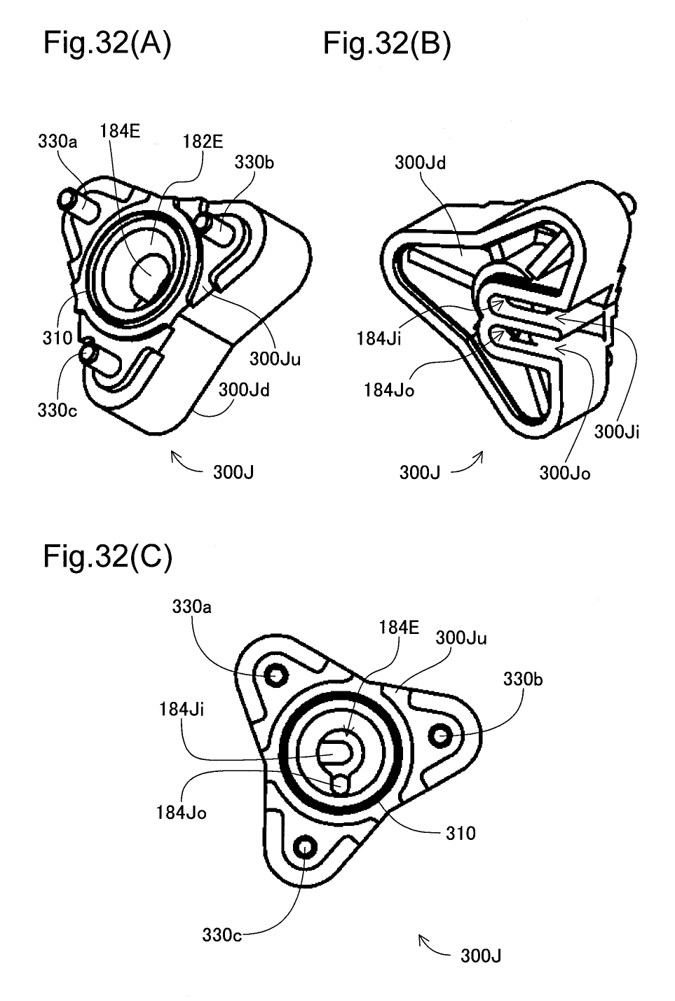

FIGS. 32 (A) and 32 (B) are perspective views of the spring seat member 300J. FIG. 32 (C) is a front view of the first surface 300Ju of the spring seat member 300J in which the membrane valve 500J is installed. The spring seat member 300J is a roughly column shaped member that extends from the second surface 300Jd to the first surface 300Ju. The membrane valve 500J (FIG. 31) is installed on the first surface 300Ju. The axes 330a, 330b, and 330c, and the loop shaped rib 310 are formed on the first surface 300Ju. The downstream valve chamber 182E and the spring accommodating chamber 184E are formed in the area surrounded by the rib 310. The respective constitutions of the rib 310, the downstream valve chamber 182E, and the spring accommodating chamber 184E are the same as those of the sixth embodiment. Also, as shown in FIG. 32 (B), the inflow path 300Ji and the outflow path 300Jo are formed on the second surface 300Jd. In a state with the spring seat member 300J installed in the main body 110J, the inflow path 300Ji is linked to the first flow path 462J, and the outflow path 300Jo is linked to the second flow path 464J. The entirety of the inflow path 300Ji and the first flow path 462J correlates to the valve upstream path 170 in FIG. 3. The entirety of the outflow path 300Jo and the second flow path 464J correlates to the valve downstream path 190 in FIG. 3.

As shown in FIG. 32 (C), the inflow hole 184Ji is formed on the bottom of the spring accommodating chamber 184E, and the outflow hole 184Jo is formed on the side surface of the spring accommodating chamber 184E. As shown in FIG. 32 (B), the inflow hole 184J is linked to the inflow path 300Ji, and the outflow hole 184Jo is linked to the outflow path 300Jo.

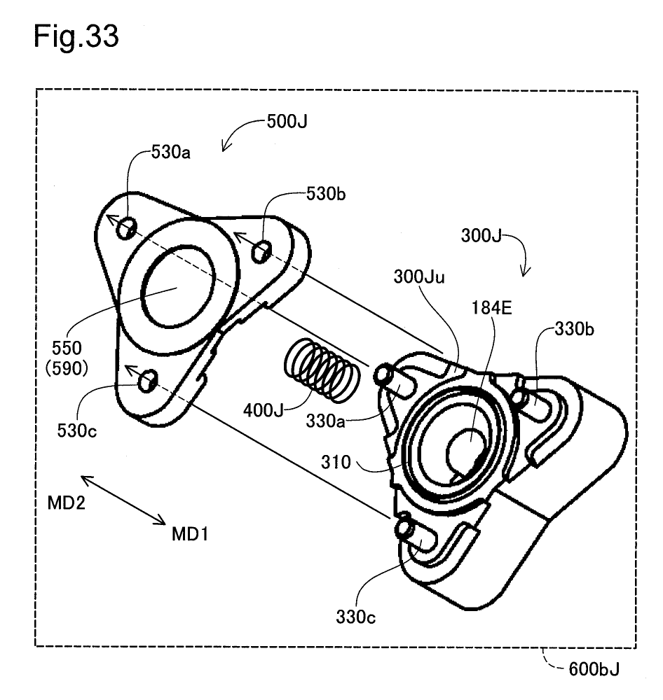

FIG. 33 is an exploded perspective view of the valve assembly 600bJ. The coil spring 400J is inserted in the spring accommodating chamber 184E. In this state, the membrane valve 500J is installed on the first surface 300Ju of the spring seat member 300J. The axes 330a, 330b, and 330c of the spring seat member 300J are respectively inserted in the holes 530a, 530b, and 530c of the membrane valve 500J. In a state with the membrane valve 500J installed in the spring seat member 300J, it is acceptable as long as the side surface of the axis 330a is connected to at least part of the inner surface of the hole 530a. With this embodiment, the inner diameter of the hole 530a is almost the same as the outer diameter of the axis 330a, but the inner diameter of the hole 530a can also be smaller than the outer diameter of the axis 330a. The same is also true for other combinations of holes and axes.

The valve assembly 600bJ is fit in the valve storage chamber 600aJ (FIG. 30). At this time, the first surface 300Ju of the spring seat member 300J faces the valve wall 600awJ of the valve storage chamber 600aJ. Also, the membrane valve 500J is sandwiched by the first surface 300Ju of the spring seat member 300J and the valve wall 600awJ of the valve storage chamber 600aJ.

With this embodiment, the contour of the spring seat member 300J in the cross section parallel to the membrane valve 500J is almost the same as the contour of the membrane valve 500J (FIG. 31 (C) and FIG. 32 (C)). Also, the shape of the valve storage chamber 600aJ that receives the valve assembly 600bJ is a roughly column shape that has almost the same cross section shape. In this way, as the respective outer shape of the valve storage chamber 600aJ and the valve assembly 600bJ, a simple column shape is used. Therefore, it is possible to make the constitution of the valve section 180J simple.

The cross section constitution of the valve section 180J is the same as the sixth embodiment (FIG. 25 to FIG. 27). Therefore, this embodiment has the same various advantages as the sixth embodiment. Also, as shown in FIG. 33, using a simple constitution of the respective axes 330a, 330b, and 330c inserted in the holes 530a, 530b, and 530c, the position of the valve main portion 555E is determined. As a result, it is possible to reduce the possibility of an unintentional force being applied to the outer periphery of the seal portion 520 (valve main portion 555E). As a result, it is possible to reduce the possibility of unintentional deformation of the valve main portion 555E due to position determination.

Also, the same as with the ends 564 and 574 of the fifth embodiment shown in FIG. 15, when the membrane valve 500J with the end of the projecting portion 556 facing the plane is placed on that plane, the three ends 564a, 564b, and 564c are in contact with that plane, and support the membrane valve 500J. Also, in a state with the membrane portion 510 in a state not deformed, the end of the projecting portion 556 is in contact with that plane. Therefore, by placing the membrane valve 500J on the plane, it is possible to reduce the possibility of deformation of the membrane portion 510. Note that the entirety of the three installing portions 560a, 560b, and 560c correlates to the “first support portion.” Also, when placed on another plane on the side facing opposite the membrane valve 500J, the end 522 supports the other plane, just like the fifth embodiment. Also, the membrane portion 510 and the contact area 590 are separated from the other plane. Therefore, it is possible to overlap a pallet or the like on the membrane valve 500.

Note that the cross section constitution of the valve section 180J of this embodiment can replace the valve section 180J with the valve sections of the embodiments 1 to 5 to have the same kind of cross section constitutions as the valve sections of the embodiments 1 to 5. Also, the constitution of the valve section 180J of this embodiment is not limited to being used for the ink cartridge 100E of the sixth embodiment, but can also be used for the ink cartridge 100 of the first embodiment.

### J. Modified Embodiments

Note that among the constitutional elements of each embodiment noted above, the elements other than elements claimed with the independent claims are additional elements, and can be omitted as appropriate. Also, the present invention is not limited to the embodiments and aspects noted above, but can be implemented in various modes in a scope that does not stray from the spirit of the invention, and for example the following variations are possible.

### First Modified Embodiment

With the embodiments noted above, the circuit board 13 and the sensing section 105 are provided, but it is also possible to not provide these.

Also, for the parts other than the constitution of the valve section, it is possible to suitably change the shape or position within a scope that does not stray from the spirit of the invention. For example, it is possible to change the position at which the ink supply port 120 or the lever 11 is provided, and to provide them on a surface different from those of these embodiments. It is also possible to change or to eliminate the shape of the lever 11. Furthermore, it is possible to make the outline of the cartridge a different shape, to change the shape or position of the ribs that partition the inside of the fluid container, or to constitute the main body divided into a plurality of parts.

### Second Modified Embodiment

With the embodiments noted above, one ink tank is constituted as one ink cartridge, but it is also possible to constitute a plurality of ink tanks as one ink cartridge.

### Third Modified Embodiment

The embodiments noted above adopt an inkjet type printer and ink cartridges, but it is also possible to adopt a liquid jetting device that sprays or blows out a liquid other than ink, and a liquid container that stores that liquid. This can also be diverted for use as various types of liquid consumption devices equipped with a liquid spraying head that blows out very small volumes of liquid drops. Note that liquid drops means a state with fluid being blown out from the aforementioned fluid jetting device, and includes grain shapes, teardrop shapes, and thread shapes after which a tail is drawn. Also, the liquid noted here is acceptable as long as it is a material that can be jetted by a liquid jetting device. For example, a state when the substance is in a liquid phase is acceptable, and includes not only fluid states such as high or low viscosity liquid states, sol, gel water, and other inorganic solvents, organic solvent, solutions, liquid resins, liquid metals (metal melt), or liquids as one state of a substance, but also items for which particles of a functional material consisting of solids such as pigments or metal particles or the like are dissolved, dispersed, or mixed in a solvent or the like. Also, representative examples of a liquid include the kind of inks described with the modes of the embodiments noted above, liquid crystal, or the like. Here, an ink means an item that contains various types of liquid compositions such as a typical water based ink and oil based ink as well as gel ink, hot melt ink and the like. As a specific example of a liquid jetting device, examples can be a liquid jetting device that sprays a liquid containing in a dispersed or dissolved mode a material such as an electrode material or coloring material or the like used in the manufacturing of liquid crystal displays, EL (electroluminescence) displays, surface light emitting displays, color filters, or the like, a liquid jetting device that sprays a biological organic substance for used in biochip manufacturing, or a liquid jetting device used as a precision pipette that sprays a liquid that will become a sample. Furthermore, it is also possible to adopt a liquid jetting device that sprays lubricating oil with a pinpoint on precision machines such as a clock, camera or the like, a liquid jetting device that sprays onto a substrate a transparent resin liquid such as an ultraviolet ray hardening resin or the like to form a micro hemispherical lens (optical lens) used for optical communication elements and the like, or a liquid jetting device that sprays an etching fluid such as acid, alkali or the like to etch a substrate or the like. Then, it is also possible to apply the present invention to any one type of these jetting devices and to a liquid container.

Also, with each of the embodiments described above, the specific gravity of the membrane valve is lower than the specific gravity of the liquid that flows in the valve (e.g. ink). However, the specific gravity of the membrane valve can also be the same as the specific gravity of the liquid, and can also be higher than the specific gravity of the liquid. Also, the present invention is not limited to a liquid container placed on a carriage that moves back and forth in a liquid consumption device (on-carriage type liquid container), but can also be used for a liquid container placed on a liquid storage unit that does not move (off-carriage type liquid container).

### Fourth Modified Embodiment

With the embodiments noted above, the number of engaging portions provided on the membrane valve (e.g. the holes 530 and 540 in FIG. 5) was 2 or 3, but this can also be 4 or more. In other words, it is acceptable as long as the position of the valve main portion is determined by the N (N is an integer of 2 or greater) engaging portions arranged mutually separated in the periphery of the valve main portion (e.g. the valve main portion 555 in FIG. 12). By working in this way, compared to when the position is determined using the entire outer periphery of the valve main portion, it is possible to reduce the possibility of an unintentional force being added to the valve main portion. However, when the number N becomes too high, the constitution of the membrane valve or the constitution of the liquid container becomes complex, and there is the possibility of the membrane valve or the liquid container becoming large. From this kind of perspective, it is preferable that N be a low number, so 2 or 3 noted in the above embodiments are suitable, and that 2 is particularly desirable.

### Fifth Modified Embodiment

With each of the embodiments noted above, as the shape of the projecting portion (projecting portion of the membrane) inserted inside of one end of the coil spring, the shape is not limited to the shape of the projecting portion 556 of FIG. 13 or the shape of the projecting portion 556F of FIG. 28, and various shapes can be used. For example, it is also possible to use a shape for which part of the outer periphery sinks in, or a reverse taper shape.

### Sixth Modified Embodiment

The area of the second contact areas S2, S2E can also be larger than the area of the first contact areas S1, S1E (see FIG. 14 (A), FIG. 27, etc.). In this case, it is preferable that the contact position CP of the membrane portion 510 and the seal portion 520 be arranged at a position closer to the downstream seal surface 524 than the upstream seal surface 522. Also, in this case, the upstream seal surface 522 correlates to the “second seal surface” of modes 29 and 31, and the downstream seal surface 524 correlates to the “first seal surface.” Note that the side surface 526 can also intersect diagonally with the seal surfaces 522 and 524. In either case, it is acceptable as long as a comparison is done of the distance in the direction perpendicular to the seal surfaces 522 and 524 between the thickness direction center MC of the membrane portion 510 at the connection position CP and the seal surfaces 522 and 524.

Also, it is possible to use various shapes as the shape of the membrane portion 510 etc., the spring receiving portion 552 etc., the projecting portion 556 etc., and the spring accommodating chamber 184 etc. As several examples of these, modified embodiments of the projecting portion and the spring accommodating chamber will be described below.

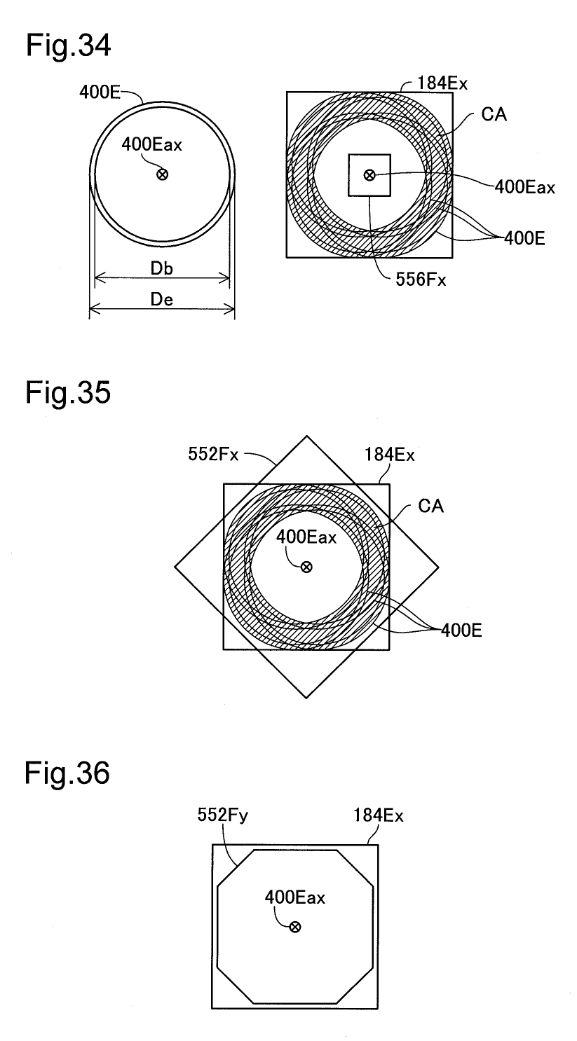

FIG. 34 is an explanatory drawing showing a modified embodiment of the projecting portion and the spring accommodating chamber. In the drawing, the cross section perpendicular to the center axis 400Eax of the coil spring 400E with the coil spring 400E, the spring accommodating chamber 184E, and the projecting portion 556Fx is shown. The cross section of the spring accommodating chamber 184Ex is a rectangle that is larger than the coil spring 400E. The rectangle of the spring accommodating chamber 184Ex in the drawing shows the inner wall of the spring accommodating chamber 184Ex. Inside the spring accommodating chamber 184Ex, the coil spring 400E can move in the direction perpendicular to the center axis 400Eax. The area CA shown by cross hatching indicates the range of the position for which contact is possible with the end of the coil spring 400E by the coil spring 400E moving. The projecting portion 556F is arranged at the center axis 400Eax side separated from this contact area CA. Therefore, the same as with the seventh embodiment, it is possible to reduce the possibility of the coil spring 400E becoming adhered to the projecting portion 556Fx. Note that in FIG. 34, the cross section shape of the projecting portion 556Fx is rectangular. However, the cross section shape of the projecting portion is not limited to being a circle or rectangle, but can be any desired shape. The cross section shape of the spring accommodating chamber 184Ex is also not limited to being a circle or rectangle, but can be any desired shape.

FIG. 35 is an explanatory drawing showing a modified embodiment of the spring receiving portion. In the drawing, in addition to the same spring accommodating chamber 184Ex as the modified embodiment of FIG. 34, the spring receiving portion 552Fx is also shown. With this embodiment, the spring receiving portion 552Fx widens to the outside of the contact area CA. Therefore, the same as with the seventh embodiment, when the position of the coil spring 400E is skewed inside the spring accommodating chamber 184Ex, it is possible to reduce the possibility of the end part of the coil spring 400E from coming off the spring receiving portion 552Fx. Note that in FIG. 35, the profile shape of the cross section of the spring receiving portion 552Fx is rectangular. However, the profile shape of the cross section of the spring receiving portion is not limited to being a circle or rectangle, but can be any desired shape. For example, part of the profile shape of the cross section of the spring receiving portion can be inside the contact area CA.

FIG. 36 is an explanatory drawing showing yet another modified embodiment of the spring receiving portion. In the drawing, in addition to the spring accommodating chamber 184Ex that is the same as the modified embodiment of FIG. 34, the spring receiving portion 552Fy is shown. With this embodiment, when projected in the spring accommodating chamber 184Ex along the center axis 400Eax, the spring receiving portion 552Fy is arranged at a position that does not overlap with the inner wall of the spring accommodating chamber 184Ex. Therefore, it is possible to reduce the possibility of the spring receiving portion 552F adhering to the spring accommodating chamber 184Ex, just like the embodiment in FIG. 29. Note that in FIG. 36, the profile shape of the cross section of the spring receiving portion 552Fy is a polygonal shape. However, the profile shape is not limited to being a circle or a polygon, but can be any desired shape.

### Seventh Modified Embodiment

With the embodiments described above, as shown in FIG. 3, the valve section (for example, the valve section 180) is provided between the ink storage chamber 140 and the supply port 120a. Specifically, the valve upstream path 170 is linked to the ink storage chamber 140, and the valve downstream path 190 is linked to the supply port 120a. Here, it is also possible to use the valve sections 180, 180E, 180F, 180G, and 180J of the embodiments described above as the atmospheric valve for introducing the atmosphere. In specific terms, the valve section can be provided between the air opening hole 130a and the ink storage chamber 140. In this case, the valve upstream path is linked to the air opening hole 130a, and the valve downstream path is linked to the ink storage chamber 140. By consumption of the ink, the pressure (air pressure) in the valve downstream path is decreased. Also, when the absolute value of the difference between the pressure in the valve upstream path (atmospheric pressure) and the pressure in the valve downstream path (air pressure) (differential pressure) exceeds a specified pressure, the valve section opens, and air is introduced from the air opening hole 130a to the ink storage chamber 140. Also, this valve section suppresses the flow of ink from the ink storage chamber 140 to the air opening hole 130a. In this way, the valve section can also be a fluid (including at least one of liquid or gas) valve.

### Eighth Modified Embodiment

With the first and fifth embodiments (see FIG. 15), it is also possible to have the downstream seal surface 524 of the seal portion 520 be moved to the position TD1, and to have the downstream seal surface 524 be in contact with the first plane P1 and support the membrane valve 500. Also, with the first and fifth embodiments (see FIG. 16), it is also possible to have the installing portions 560 and 570 project in the reverse direction to the thickness direction TD, and instead of the upstream seal surface 522, to have the end of the installing portions 560 and 570 support the second plane P2. These modifications can also be applied to the other embodiments.

Typically, the first support portion is acceptable if it surrounds the projecting portion that is affixed to the membrane portion and moves according to the deformation of the membrane portion. It is also possible to have the first contact area of the first support portion and the first plane surround the end of the projecting portion. Also, in a state with the membrane portion not being deformed, it is possible to have the end of the projecting portion be in contact with the first plane. By doing this, it is possible to have the first support portion be in contact with the first plane and support the membrane valve without applying an excess load to the projecting portion. Similarly, the second support portion can also be formed so as to surround the membrane portion. Also, the second contact area of the second support portion and the second plane can surround the membrane portion. Also, in a state without deformation of the membrane portion, it is also possible to arrange the entire membrane portion at a position lower than the second plane. By doing this, when a pallet or the like is overlapped on the membrane valve, it is possible to reduce the possibility of the membrane portion contacting the second plane. It is also possible to have the second contact area surround the movable seal (e.g. the contact area 590). In a state with the membrane portion not deformed, it is possible to arrange the entire movable seal at a position lower than the second plane. By doing this, when a pallet or the like is overlapped on the membrane valve, it is possible to reduce the possibility of the movable seal contacting the second plane.

In either case, the contact area can be one continuous area, or can be divided into a plurality of mutually separated sub areas. When the first contact area is divided into a plurality of sub areas, it is possible to arrange the end of the projecting portion inside the enclosed area formed by the plurality of sub areas. Here, the enclosed area means the area for which the contour is formed by the sub areas and a straight line that connects between sub areas, and is the area that includes all the sub areas, and for which the area is maximum. For example, with the first and fifth embodiments (see FIG. 15 (B)), the area A1 surrounded by the end 564, the first straight line L1, the end 574, and the second straight line L2 correlates to the enclosed area. Also, with the ninth embodiment (see FIG. 31 (D)), the area A11 surrounded by the end 564a, the first straight line L11, the end 564b, the second straight line L12, the end 564c, and the third straight line L13 correlates to the enclosed area. However, the end of the projecting portion can also be arranged outside the enclosed area. Similarly, when the second contact area is divided into a plurality of sub areas, it is also possible to have the position projecting along the direction perpendicular to the second plane P2 of at least one of the membrane portion and the movable seal be arranged inside the enclosed area formed by the plurality of sub areas. However, it is also possible to have the projection position of at least one of the membrane portion and the movable seal arranged outside the enclosed area.

### Ninth Modified Embodiment

Above, various modes are described, but the following kind of modes can also be used.

Mode 1. A liquid container that can be installed in a liquid jetting device, comprising:

a main body having a liquid storage chamber that stores liquid, a liquid supply port that supplies the liquid to the liquid jetting device, a first flow path linked to the liquid storage chamber, and a second flow path linked to the liquid supply port; and

a membrane valve that is interposed between the first flow path and the second flow path, and has a membrane portion, wherein

the membrane valve has a first surface and a second surface opposite the first surface,

the first surface receives a first fluid pressure of the liquid in the first flow path, and

the second surface receives a second fluid pressure of the liquid in the second flow path, wherein

when a differential pressure of the first fluid pressure relative to the second fluid pressure exceeds a specified pressure, the membrane portion of the membrane valve deforms to an open valve state in which the first flow path and the second flow path are linked, and when the differential pressure is the specified pressure or less, the membrane portion deforms to a closed valve state in which the first flow path and the second flow path are not linked, and

the membrane valve is formed with an elastomer.

By working in this way, the membrane valve is formed using an elastomer, so the deformation of the membrane portion of the membrane valve in relation to pressure is stabilized, so the negative pressure generated by the membrane valve is stabilized.

Mode 2. A liquid container in accordance with mode 1, wherein

the membrane valve is arranged so that the membrane portion is substantially perpendicular to the gravitational force direction, in a state that the liquid container is installed in the liquid jetting device.

By working in this way, the membrane portion is arranged so as to be roughly perpendicular to the gravitational force direction, so the variation due to gravitational force of the fluid pressure applied to the membrane portion is small. As a result, deformation of the membrane portion of the membrane valve in relation to fluid pressure is stabilized, so the negative pressure generated by the membrane valve is stabilized.

Mode 3. A liquid container in accordance with mode 2, wherein

the first surface faces upward, and the second surface faces downward,

on the first surface, the membrane valve has a contact area and a pressure receiving area that receives the first fluid pressure,

the main body further has a relay flow path of which one end is linked to the second flow path, wherein the other end of the relay flow path is in contact with the contact area in the closed valve state, and the other end is linked to the first flow path in the open valve state, and

the contact area is in a lower position than the pressure receiving area, in a state that the liquid container is installed in the liquid jetting device.

By working in this way, with the second flow path, the contact area is at a lower position than the pressure receiving area, so liquid is not left remaining in the second flow path, and it is possible to flow into the relay flow path without waste. As a result, it is possible to provide a liquid consumption device without waste of the liquid in the liquid container.

Mode 4. A liquid container in accordance with mode 2, wherein

the first surface faces upward, and the second surfaces faces downward,

the liquid container further comprises:
an elastic member that urges the membrane valve in a direction from the second surface toward the first surface, and

a specific gravity of the membrane valve is lower than a specific gravity of the liquid.

By working in this way, the membrane valve receives buoyancy force, so it is possible to make the elastic member compact.

Mode 5. A liquid container in accordance with mode 4, wherein

the elastic member is made of an elastomer, and is formed as a single unit with the membrane valve.

By working in this way, it is possible to reduce the number of parts.

Mode 6. A liquid container in accordance with mode 1, further comprising:

an elastic member that presses the second surface of the membrane valve, the elastic member being formed with an elastomer.

By working in this way, it is possible to suppress holding of the liquid by the elastic member. As a result, it is possible to supply liquid in the liquid container to the liquid consumption device without waste.

Mode 7. A liquid container in accordance with mode 6, wherein

the elastic member is formed as a single unit with the membrane valve.

By working in this way, it is possible to reduce the number of parts.

Mode 8. A membrane valve used in a liquid container that can be installed in a liquid jetting device, the liquid container having a liquid storage chamber for storing liquid, a liquid supply port for supplying the liquid to the liquid jetting device, a first flow path linked to the liquid storage chamber, and a second flow path linked to the liquid supply port, wherein the membrane valve is interposed between the first flow path and the second flow path, wherein

the membrane valve comprises a valve body, wherein

the valve body comprises:

a first surface that receives a first fluid pressure of the liquid in the first flow path,

a second surface opposite the first surface that receives a second fluid pressure of the liquid in the second flow path, and

a membrane portion that deforms to an open valve state in which the first flow path and the second flow path are linked, when a differential pressure of the first fluid path relative to the second flow path exceeds a specified pressure, and deforms to a closed valve state in which the first flow path and the second flow path are not linked, when the differential pressure is the specified pressure or lower, wherein

the valve body is formed with an elastomer.

Mode 9. A membrane valve in accordance with mode 8, wherein

the membrane valve is arranged so that the membrane portion is substantially perpendicular to the gravitational force direction, in a state that the liquid container is installed in the liquid jetting device.

Mode 10. A membrane valve in accordance with mode 9, wherein

the first surface of the valve body has a contact area and a pressure receiving area that receives first fluid pressure,

the liquid container further has a relay flow path of which one end is linked to the second flow path, wherein the other end of the relay flow path is in contact with the contact area in the closed valve state, and the other end is linked to the first flow path in the open valve state, and

the contact area is in a lower position than the pressure receiving area, in a state that the liquid container is installed in the liquid jetting device.

Mode 11. A membrane valve in accordance with mode 9, wherein

a specific gravity of the membrane valve is lower than a specific gravity of the liquid.

Mode 12. A membrane valve in accordance with mode 11, further comprising

an elastic member that urges the valve body in a direction from the second surface toward the first surface, wherein

the elastic member is made of an elastomer, and is formed as a single unit with the valve body.

Mode 13. A membrane valve that is supported by a membrane support portion, is interposed between a first flow path and a second flow path, and is used in a valve that links the first flow path and the second flow path in an open state and blocks the link between the first flow path and the second flow path in a closed state, the membrane valve comprising:

a valve main portion, and

an attachment portion affixed to the valve main portion, wherein

the valve main portion includes:

a membrane portion that deforms according to a difference between a first pressure in the first flow path and a second pressure in the second flow path; and

a movable portion that is affixed to the membrane portion, and moves according to the deformation of the membrane portion to open and close the valve, wherein

the attachment portion includes N (N is an integer of 2 or greater) engaging portions that engage with the membrane support portion.

With this constitution, the position of the membrane valve is determined by the N (N is an integer of 2 or greater) engaging portions, so it is possible to reduce the possibility of position skew of the movable seal.

Mode 14. A membrane valve in accordance with mode 13, wherein

the engaging portion includes an engaging hole in which an engaging axis is inserted, the engaging axis being formed on the membrane support portion, the engaging hole extending along a same direction as a movement direction of the movable portion.

With this constitution, it is possible to suitably reduce the possibility of position skew of the movable seal in the direction perpendicular to the movement direction.

Mode 15. A membrane valve in accordance with mode 14, wherein

a side surface of the engaging axis contacts at least part of an inner surface of the engaging hole in a state that the engaging axis is inserted in the engaging hole.

With this constitution, it is possible to suitably reduce the possibility of position skew of the movable seal.

Mode 16. A membrane valve in accordance with mode 14, wherein

an inner diameter of the engaging hole is smaller than or substantially same as an outer diameter of the engaging axis.

With this constitution, it is possible to easily have at least one part of the inner surface of the engaging hole be in contact with the side surface of the engaging axis.

Mode 17. A membrane valve in accordance with mode 13, wherein

the membrane valve is a valve used in a state that a coil spring that urges the movable portion in a specified direction is in contact with the valve main portion, and

the valve main portion includes a projecting portion to be inserted inside one end of the coil spring, the projecting portion including a part of which an outer diameter is substantially same as an inner diameter of the coil spring.

With this constitution, it is possible to reduce the possibility of the coil spring having position skew in relation to the projecting portion.

Mode 18. A membrane valve in accordance with mode 13, wherein

the valve main body includes:

a first surface in the first flow path side; and

a second surface opposite the first surface in the second flow path side,

the membrane valve is a valve used in a state that a seal receiving portion is arranged on the first surface side of the valve main portion,

the movable portion is a movable seal that can contact the seal receiving portion,

the membrane portion deforms such that the movable seal separates from the seal receiving portion and the first flow path and the second flow path are linked, when a difference of the first pressure relative to the second pressure exceeds a specified pressure, and

the membrane portion is deformed such that the movable seal presses against the seal receiving portion and blocks the link between the first flow path and the second flow path, when the difference is the specified pressure or lower.

With this constitution, it is possible to suitably perform opening and closing of the communication hole.

Mode 19. A membrane valve in accordance with mode 13, wherein

the valve main portion includes a looped seal portion formed on an outer periphery of the valve main portion,

the attachment portion includes:

a first attachment portion affixed to part of an outer periphery of the seal portion, and

a second attachment portion affixed to part of remaining part of the outer periphery of the seal portion, wherein

the first attachment portion and the second attachment portion respectively include the engaging portion.

With this constitution, it is possible to affix the attachment portion to part of the seal portion, so it is possible to make the membrane valve more compact.

Mode 20. A liquid container that can be installed in a liquid jetting device, comprising:

a liquid storage chamber that stores liquid;

a liquid supply port that supplies the liquid to the liquid jetting device;

a first flow path;

a second flow path; and

a valve that links the first flow path and the second flow path in an open state, and blocks the link between the first flow path and the second flow path in a closed state, wherein

the first flow path or the second flow path is linked to the liquid storage chamber, wherein

the valve includes:

a membrane valve; and

a membrane support portion that supports the membrane valve, wherein

the membrane valve is interposed between the first flow path and the second flow path, wherein

the membrane valve includes:

a valve main portion; and

an attachment portion affixed to the valve main portion, wherein

the valve main portion includes:

a membrane portion that deforms according to a difference between a first pressure in the first flow path and a second pressure in the second flow path; and

a movable portion that is affixed to the membrane portion, and moves according to the deformation of the membrane portion to open and close the valve, wherein

the attachment portion includes N (N is an integer of 2 or greater) engaging portions that engage with the membrane support portion.

Mode 21. A liquid container in accordance with mode 20, wherein

the membrane support portion includes N engaging axes that engage with the engaging portion, the engaging portion including an engaging hole in which the engaging axis is inserted, the engaging hole extending along a same direction as a movement direction of the movable portion.

Mode 22. A liquid container in accordance with mode 21, wherein

a side surface of the engaging axis contacts at least part of an inner surface of the engaging hole in a state that the engaging axis is inserted in the engaging hole.

Mode 23. A liquid container in accordance with mode 21, wherein

an inner diameter of the engaging hole is smaller than or substantially same as an outer diameter of the engaging axis.

Mode 24. A liquid container in accordance with mode 20, further including

a coil spring that contacts with the valve main portion and urges the movable portion in a specified direction, and

the valve main portion includes a projecting portion to be inserted in an inside of one end of the coil spring, the projecting portion including a portion of which an outer diameter is substantially same as an inner diameter of the coil spring.

Mode 25. A liquid container in accordance with mode 24, wherein

the membrane support portion includes a first concave portion that receives the other end of the coil spring, an inner diameter of the first concave portion being larger than an outer diameter of the coil spring.

With this constitution, it is possible to lighten the friction between the coil spring and the first concave portion, so it is possible to make expansion and contraction of the coil spring smooth. Thus, the valve opening and closing is stable, and it is possible to do stable control of the differential pressure.

Mode 26. A liquid container in accordance with mode 20, wherein

the valve main portion includes:

a first surface in the first flow path side; and

a second surface opposite the first surface in the second flow path side, wherein

the liquid container has a seal receiving portion arranged on the first surface side of the valve main portion, and

the movable portion is a movable seal that can contact the seal receiving portion, wherein

the membrane portion deforms such that the movable seal separates from the seal receiving portion and the first flow path and the second flow path are linked, when the difference of the first pressure relative to the second pressure exceeds a specified pressure, and

the membrane portion deforms such that the movable seal is pressed against the seal receiving portion and blocks the link between the first flow path and the second flow path, when the difference is the specified pressure or less.

Mode 27. A liquid container in accordance with mode 20, wherein

the valve main portion includes a looped seal portion that forms an outer periphery of the valve main portion,

the attachment portion includes:

a first attachment portion affixed to part of an outer periphery of the seal portion; and

a second attachment portion affixed to part of remaining part of the outer periphery of the seal portion, and

the first attachment portion and the second attachment portion respectively include the engaging portion.

With the liquid container of modes 26 and 27, a membrane valve having the respective constitutions of modes 18 and 19 are used, so the valve opening and closing is stable, and it is possible to do stable control of the differential pressure.

Mode 28. A liquid container in accordance with mode 20, including

a second concave portion in which the membrane support portion that supports the membrane valve fits, wherein

the membrane valve is formed in a substantial plate shape,

the membrane support portion is formed in a column shape of which a contour in a cross section parallel to the membrane valve is substantially same as a contour of the membrane valve, in a state that the membrane valve is supported on the membrane support portion, and

the membrane valve is sandwiched between the second concave portion and the membrane support portion.

With this constitution, it is possible to make the valve constitution simple.

Mode 29. A membrane valve that is interposed between a first flow path and a second flow path, and is used in a valve that links the first flow path and the second flow path in an open state and blocks the link between the first flow path and the second flow path in a closed state, comprising:

a membrane portion that deforms according to a difference between a first pressure in the first flow path and a second pressure in the second flow path; and

a seal portion that is affixed to the membrane portion and is thicker than the membrane portion, wherein

the membrane valve is a valve used in a first state in which the seal portion is sandwiched between a first member and a second member, and

the seal portion includes:

a first seal surface in contact with the first member in the first state; and

a second seal surface in contact with the second member in the first state, wherein

a contact area between the first seal surface and the first member is larger than a contact area between the second seal surface and the second member, and

the membrane portion is affixed at a position in the seal portion that is closer to the first seal surface than the second seal surface between a plane including the first seal surface and a plane including the second seal surface.

With this constitution, when the seal portion is deformed, it is possible to reduce the possibility of the membrane portion deforming to an unintended shape.

Mode 30. A membrane valve in accordance with mode 29, further including:

a first surface in the first flow path side;

a second surface opposite the first surface in the second flow path side; and

a movable seal that is affixed to the membrane portion, and moves according to the deformation of the membrane portion to open and close the valve, wherein

the membrane valve is a valve used in a state that a seal receiving portion is arranged at the first surface side of the membrane valve, wherein

the membrane portion deforms such that the movable seal separates from the seal receiving portion and the first flow path and the second flow path are linked, when the difference between the first pressure relative to the second pressure exceeds a specified pressure, and

the membrane portion deforms such that the movable seal presses against the seal receiving portion, and blocks the link between the first flow path and the second flow path, when the difference is the specified pressure or lower.

With this constitution, it is possible to suitably perform opening and closing of the communication hole.

Mode 31. A liquid container that can be installed in a liquid jetting machine, comprising:

a liquid storage chamber that stores liquid;

a liquid supply port that supplies the liquid to the liquid jetting device;

a first flow path;

a second flow path; and

a valve that links the first flow path and the second flow path in an open state, and blocks the link between the first flow path and the second flow path in a closed state, wherein

the first flow path or the second flow path is linked to the liquid storage chamber,

the valve includes a membrane valve interposed between the first flow path and the second flow path, and

the membrane valve includes:

a membrane portion that deforms according to a difference between a first pressure in the first flow path and a second pressure in the second flow path; and

a seal portion that is affixed to the membrane portion, and is thicker than the membrane portion, wherein

the liquid container includes a first member and a second member that sandwich the seal portion,

the seal portion includes: a first seal surface that contacts the first member in the first state; and a second seal surface that contacts the second member in the first state, a contact area of the first seal surface and the first member being larger than a contact area of the second seal surface and the second member, wherein

the membrane portion is affixed at a position in the seal portion that is closer to the first seal surface than the second seal surface between a plane including the first seal surface and a plane including the second seal surface.

Mode 32. A liquid container in accordance with mode 31, further including:

a first surface in the first flow path side;

a second surface opposite the first surface in the second flow path side; and

a movable seal that is affixed to the membrane portion, and moves according to the deformation of the membrane portion to open and close the valve, wherein

the liquid container includes a seal receiving portion arranged at the first surface side of the membrane valve, wherein

the membrane portion deforms such that the movable seal separates from the seal receiving portion, and the first flow path and the second flow path are linked, when the difference between the first pressure relative to the second pressure exceeds a specified pressure, and

the membrane portion deforms such that the movable seal presses against the seal receiving portion, and blocks the link between the first flow path and the second flow path, when the difference is the specified pressure or lower.

With this liquid container of modes 31 and 32, membrane valves having the respective constitutions of modes 29 and 30 are used, so the valve opening and closing is stable, and it is possible to do stable control of the differential pressure.

Mode 33. A membrane valve that is interposed between a first flow path and a second flow path, and is used in a valve that links the first flow path and the second flow path in an open state, and blocks the link between the first flow path and the second flow path in a closed state, comprising:

a membrane portion that deforms according to a difference between a first pressure in the first flow path and a second pressure in the second flow path;

a projecting portion that is affixed to the membrane portion, and moves according to the deformation of the membrane portion; and

a first support portion, wherein

in a first case where an end of the projecting portion is faced to a first plane which is a horizontal surface and the membrane valve being placed from vertically upward onto the first plane, an end of the first support portion contacts the first plane and supports the membrane valve, and the end of the projecting portion contacts the first plane in a state that the membrane portion is not deformed.

With this constitution, it is possible to reduce the possibility of deformation of the membrane portion when the membrane valve is placed on the plane.

Mode 34. A membrane valve in accordance with mode 33, wherein

the first support portion is formed so as to surround the projecting portion.

With this constitution, it possible for the first support portion to suitably support the membrane valve.

Mode 35. A membrane valve in accordance with mode 33, further including

a second support portion, wherein

in the first case, an entirety of the membrane portion is placed at a lower position than a second plane defined by a highest portion of the second support portion in a state that the membrane portion is not deformed.

With this constitution, it is possible to reduce the possibility of deformation of the membrane portion when a plane is overlapped on the membrane valve.

Mode 36. A membrane valve in accordance with mode 33, wherein

the membrane valve is formed in a substantial plate shape, and

in a state that the membrane portion is not deformed, a position of the end of the projecting portion, in a thickness direction of the membrane valve, is same as a position of the end of the first support portion in the thickness direction.

With this constitution, it is possible to suitably reduce the possibility of membrane portion deformation when the membrane valve is placed on a plane.

Mode 37. A membrane valve in accordance with mode 33, further including:

a first surface in the first flow path side;

a second surface opposite the first surface in the second flow path side; and

a movable seal that is affixed to the membrane portion and moves according to the deformation of the membrane portion to open and close the valve, wherein

the membrane valve is a valve used in a state that a seal receiving portion is arranged at the first surface side of the membrane valve, wherein

the membrane portion deforms such that the movable seal separates from the seal receiving portion, and the first flow path and the second flow path are linked, when the difference of the first pressure relative to the second pressure exceeds a specified pressure, and

the membrane portion is deformed such that the movable seal presses against the seal receiving portion and blocks the link between the first flow path and the second flow path, when the difference is the specified pressure or lower.

With this constitution, it is possible to suitably perform opening and closing of the communication hole.

Mode 38. A liquid container that can be installed in a liquid jetting device, comprising:

a liquid storage chamber that stores liquid;

a liquid supply port that supplies the liquid to the liquid jetting device;

a first flow path;

a second flow path; and

a valve that links the first flow path and the second flow path in an open state, and blocks the link between the first flow path and the second flow path in a closed state, wherein

the first flow path or the second flow path is linked to the liquid storage chamber,

the valve includes a membrane valve interposed between the first flow path and the second flow path, and

the membrane valve includes:

a membrane portion that deforms according to a difference between a first pressure in the first flow path and a second pressure in the second flow path;

a projecting portion that is affixed to the membrane portion, and moves according to the deformation of the membrane portion; and

a first support portion, wherein

the membrane valve is configured such that, in a first case where an end of the projecting portion is faced to a first plane which is a horizontal surface and the membrane valve is placed from vertically upward onto the first plane, an end of the first support portion contacts the first plane and supports the membrane valve, and the end of the projecting portion contacts the first plane in a state that the membrane portion is not deformed.

Mode 39. A liquid container in accordance with mode 38, wherein

the first support portion is formed so as to surround the projecting portion.

Mode 40. A liquid container in accordance with mode 38, wherein

the membrane valve further includes a second support portion, wherein

in the first case, an entirety of the membrane portion is placed at a position lower than a second plane defined by a highest portion of the second support portion in a state that the membrane portion is not deformed.

Mode 41. A liquid container in accordance with mode 38, wherein

the membrane valve is formed in a substantial plate shape, and

in a state that the membrane portion is not deformed, a position of the end of the projecting portion, in a thickness direction of the membrane valve, is same as a position of the end of the first support portion in the thickness direction.

Mode 42. A liquid container in accordance with mode 38, wherein

the membrane valve further includes:

a first surface in the first flow path side;

a second surface opposite the first surface in the second flow path side; and

a movable seal that is affixed to the membrane portion and moves according to the deformation of the membrane portion to open and close the valve, wherein

the liquid container includes a seal receiving portion that is arranged at the first surface side of the membrane valve, wherein

the membrane portion deforms such that the movable seal separates from the seal receiving portion, and the first flow path and the second flow path are linked, when the difference of the first pressure relative to the second pressure exceeds a specified pressure, and

the membrane portion is deformed such that the movable seal presses against the seal receiving portion and blocks the link between the first flow path and the second flow path, when the difference is the specified pressure or lower.

With the liquid containers of modes 38 to 42, membrane valves having the respective constitutions of modes 33 to 37 are used, so the valve opening and closing is stable, and it is possible to do stable control of the differential pressure.

Mode 43. A membrane valve that is arranged at a specified position facing opposite a concave portion, is urged by a coil spring of which one end is in the concave portion and the other end urge the membrane valve, is interposed between a first flow path and a second flow path, and is used in a valve that links the first flow path and the second flow path in an open state, and blocks the link between the first flow path and the second flow path in a closed state, the membrane valve comprising:

a membrane portion that deforms according to a difference between a first pressure of the first flow path and a second pressure of the second flow path; and

a projecting portion inserted in an inside of the other end of the coil spring, wherein

the projecting portion is arranged at a side of a center axis of the coil spring separated from a range of a position at which the projecting portion can contact the other end of the coil spring by moving the coil spring within the concave portion in a direction perpendicular to the center axis of the coil spring.

With this constitution, when the coil spring inside the concave portion is moved, it is possible to reduce the possibility of the coil spring contacting the projecting portion. Therefore, it is possible to reduce the possibility of the coil spring and the projecting portion having unintended adherence.

Mode 44. A membrane valve in accordance with mode 43, further including a spring receiving portion that surrounds the periphery of the projecting portion, for receiving the other end of the coil spring, for which the thickness of the spring receiving portion is thicker than the thickness of the membrane portion.

With this constitution, it is possible to reduce the possibility of the membrane valve being damaged by the coil spring.

Mode 45. A membrane valve in accordance with mode 44, wherein the spring receiving portion widens to the outside of the scope of the position for which it is possible to contact the other end of the coil spring by moving the coil spring within the concave portion in the direction perpendicular to the center axis of the coil spring.

With this constitution, wherein when the position of the coil spring is skewed inside the concave portion, it is possible to reduce the possibility of the end part of the coil spring coming off from the spring receiving portion.

Mode 46. A membrane valve in accordance with mode 44, wherein the spring receiving portion is arranged at a position that does not overlap the inner wall of the concave portion when projecting to the concave portion along the center axis of the coil spring.

With this constitution, it is possible to reduce the possibility of the spring receiving portion contacting the wall of the concave portion.

Mode 47. A membrane valve in accordance with any of modes 43 through 46, wherein the outer diameter of the projecting portion is smaller the closer it is to the tip of the projecting portion.

With this constitution, it is possible to easily insert the end of the projecting portion into the inside of the end of the coil spring.

Mode 48. A membrane valve in accordance with any of modes 43 through 47, further including a first surface on the first flow path side, a second surface on the second flow path side which is the surface on the side facing opposite the first surface, and a movable seal affixed to the membrane portion that moves according to deformation of the membrane portion and opens and closes the valve, wherein the membrane valve is a membrane valve used in a state with the seal receiving portion arranged on the first surface side of the membrane valve, and when the difference between the first pressure and the second pressure (differential pressure) exceeds a specified pressure, the membrane portion deforms so that the movable seal separates from the membrane portion and the first flow path and the second flow path are linked, and when the differential pressure exceeds the specified pressure, the movable seal is pressed against the seal receiving portion, and the membrane portion is deformed so as to block the link between the first flow path and the second flow path.

With this constitution, it is possible to suitably perform opening and closing of the communication hole.

Mode 49. A liquid container that can be installed in a liquid jetting device, comprising a liquid storage chamber for storing liquid, a liquid supply port for supplying the liquid to the liquid jetting device, a first flow path, a second flow path, and a valve for linking the first flow path and the second flow path in an open state, and for blocking the link between the first flow path and the second flow path in a closed state, for which one of either the first flow path or the second flow path is linked to the liquid storage chamber, the valve includes a membrane valve interposed between the first flow path and the second flow path, the membrane valve includes a membrane portion that deforms according to the difference between a first pressure at the first flow path and a second pressure at the second flow path (differential pressure), the liquid container further including a concave portion and a coil spring for which one end is received in the concave portion and the other end urges the membrane valve, the membrane valve is arranged at a specified position facing opposite the concave portion, and the membrane valve includes a projecting portion inserted inside the other end of the coil spring, and the projecting portion is arranged at the center axis side separated from the scope of the position at which it is possible to contact the other end of the coil spring by the coil spring moving within the concave portion in the direction perpendicular to the center axis of the coil spring.

Mode 50. A liquid container in accordance with mode 49, wherein the membrane valve includes a spring receiving portion for receiving the other end of the coil spring that surrounds the periphery of the projecting portion, the thickness of the spring receiving portion being thicker than the thickness of the membrane portion.

Mode 51. A liquid container in accordance with mode 50, wherein the spring receiving portion widens to outside the scope of the position at which it is possible to contact the other end of the coil spring by the coil spring moving within the concave portion in the direction perpendicular to the center axis of the coil spring.

Mode 52. A liquid container in accordance with mode 50, wherein the spring receiving portion is arranged at a position that does not overlap with the inner wall of the concave portion when projected to the concave portion along the center axis of the coil spring.

Mode 53. A liquid container in accordance with any of modes 49 through 52, for which the outer diameter of the projecting portion is smaller the closer it gets to the tip of the projecting portion.

Mode 54. A liquid container in accordance with any of modes 49 through 53, wherein the membrane valve further contains a first surface on the first flow path side, a second surface on the second flow path side that is the surface on the side facing opposite the first surface, and a movable seal affixed to the membrane portion that moves according to the deformation of the membrane portion and opens and closes the valve, the liquid container including a seal receiving portion arranged at the first surface side of the membrane valve, and when the difference of the first pressure in relation to the second pressure (differential pressure) exceeds a specified pressure, the movable seal separates from the seal receiving portion and the membrane portion deforms so that the first flow path and the second flow path are linked, and when the differential pressure is the specified pressure or lower, the movable seal is pressed against the seal receiving portion, and the membrane portion is deformed so as to block the link between the first flow path and the second flow path.

With the liquid container of modes 49 to 54, membrane valves equipped with the respective constitutions of modes 43 to 48 are used, so the valve opening and closing is stable, and it is possible to do stable control of the differential pressure.

The various modes described above can also be suitably combined. It is also possible to omit part of the constitutions with each of the modes described above.

Above, embodiments and modified embodiments of the present invention are described, but the present invention is not limited in any way by these embodiments and modified embodiments, and it is possible to implement various modes within the scope of the spirit of the invention.

Although the present invention has been described and illustrated in detail, it is clearly understood that the same is by way of illustration and example only and is not to be taken by way of limitation, the spirit and scope of the present invention being limited only by the terms of the appended claims.

1. A liquid container that can be installed in a liquid jetting device, comprising:
a main body having a liquid storage chamber that stores liquid, a liquid supply port that supplies the liquid to the liquid jetting device, a first flow path linked to the liquid storage chamber, and a second flow path linked to the liquid supply port; and
a membrane valve that is interposed between the first flow path and the second flow path, and has a membrane portion, wherein
the membrane valve has a first surface and a second surface opposite the first surface,
the first surface receives a first fluid pressure of the liquid in the first flow path, and
the second surface receives a second fluid pressure of the liquid in the second flow path, wherein
when a differential pressure of the first fluid pressure relative to the second fluid pressure exceeds a specified pressure, the membrane portion of the membrane valve deforms to an open valve state in which the first flow path and the second flow path are linked, and when the differential pressure is the specified pressure or less, the membrane portion deforms to a closed valve state in which the first flow path and the second flow path are not linked, and the membrane valve is formed with an elastomer.

2. A liquid container in accordance with claim 1, wherein
the membrane valve is arranged so that the membrane portion is substantially perpendicular to the gravitational force direction, in a state that the liquid container is installed in the liquid jetting device.

3. A liquid container in accordance with claim 2, wherein
the first surface faces upward, and the second surface faces downward,
on the first surface, the membrane valve has a contact area and a pressure receiving area that receives the first fluid pressure,
the main body further has a relay flow path of which one end is linked to the second flow path, wherein the other end of the relay flow path is in contact with the contact area in the closed valve state, and the other end is linked to the first flow path in the open valve state, and
the contact area is in a lower position than the pressure receiving area, in a state that the liquid container is installed in the liquid jetting device.

4. A liquid container in accordance with claim 2, wherein
the first surface faces upward, and the second surfaces faces downward,
the liquid container further comprises:
an elastic member that urges the membrane valve in a direction from the second surface toward the first surface, and
a specific gravity of the membrane valve is lower than a specific gravity of the liquid.

5. A liquid container in accordance with claim 4, wherein
the elastic member is made of an elastomer, and is formed as a single unit with the membrane valve.

6. A liquid container in accordance with claim 1, further comprising:
an elastic member that presses the second surface of the membrane valve, the elastic member being formed with an elastomer.

7. A liquid container in accordance with claim 6, wherein
the elastic member is formed as a single unit with the membrane valve.

8. A membrane valve used in a liquid container that can be installed in a liquid jetting device, the liquid container having a liquid storage chamber for storing liquid, a liquid supply port for supplying the liquid to the liquid jetting device, a first flow path linked to the liquid storage chamber, and a second flow path linked to the liquid supply port, wherein the membrane valve is interposed between the first flow path and the second flow path, wherein
the membrane valve comprises a valve body, wherein
the valve body comprises:
a first surface that receives a first fluid pressure of the liquid in the first flow path,
a second surface opposite the first surface that receives a second fluid pressure of the liquid in the second flow path, and
a membrane portion that deforms to an open valve state in which the first flow path and the second flow path are linked, when a differential pressure of the first fluid path relative to the second flow path exceeds a specified pressure, and deforms to a closed valve state in which the first flow path and the second flow path are not linked, when the differential pressure is the specified pressure or lower, wherein
the valve body is formed with an elastomer.

9. A membrane valve in accordance with claim 8, wherein
the membrane valve is arranged so that the membrane portion is substantially perpendicular to the gravitational force direction, in a state that the liquid container is installed in the liquid jetting device.

10. A membrane valve in accordance with claim 9, wherein
the first surface of the valve body has a contact area and a pressure receiving area that receives first fluid pressure,
the liquid container further has a relay flow path of which one end is linked to the second flow path, wherein the other end of the relay flow path is in contact with the contact area in the closed valve state, and the other end is linked to the first flow path in the open valve state, and
the contact area is in a lower position than the pressure receiving area, in a state that the liquid container is installed in the liquid jetting device.

11. A membrane valve in accordance with claim 9, wherein
a specific gravity of the membrane valve is lower than a specific gravity of the liquid.

12. A membrane valve in accordance with claim 11, further comprising
an elastic member that urges the valve body in a direction from the second surface toward the first surface, wherein
the elastic member is made of an elastomer, and is formed as a single unit with the valve body.

13. A membrane valve that is supported by a membrane support portion, is interposed between a first flow path and a second flow path, and is used in a valve that links the first flow path and the second flow path in an open state and blocks the link between the first flow path and the second flow path in a closed state, the membrane valve comprising:
a valve main portion, and
an attachment portion affixed to the valve main portion, wherein
the valve main portion includes:
a membrane portion that deforms according to a difference between a first pressure in the first flow path and a second pressure in the second flow path; and
a movable portion that is affixed to the membrane portion, and moves according to the deformation of the membrane portion to open and close the valve, wherein
the attachment portion includes N (N is an integer of 2 or greater) engaging portions that engage with the membrane support portion.

14. A membrane valve in accordance with claim 13, wherein
the engaging portion includes an engaging hole in which an engaging axis is inserted, the engaging axis being formed on the membrane support portion, the engaging hole extending along a same direction as a movement direction of the movable portion.

15. A membrane valve in accordance with claim 14, wherein
a side surface of the engaging axis contacts at least part of an inner surface of the engaging hole in a state that the engaging axis is inserted in the engaging hole.

16. A membrane valve in accordance with claim 14, wherein
an inner diameter of the engaging hole is smaller than or substantially same as an outer diameter of the engaging axis.

17. A membrane valve in accordance with claim 13, wherein
the membrane valve is a valve used in a state that a coil spring that urges the movable portion in a specified direction is in contact with the valve main portion, and
the valve main portion includes a projecting portion to be inserted inside one end of the coil spring, the projecting portion including a part of which an outer diameter is substantially same as an inner diameter of the coil spring.

18. A membrane valve in accordance with claim 13, wherein
the valve main body includes:
a first surface in the first flow path side; and
a second surface opposite the first surface in the second flow path side,
the membrane valve is a valve used in a state that a seal receiving portion is arranged on the first surface side of the valve main portion,
the movable portion is a movable seal that can contact the seal receiving portion,
the membrane portion deforms such that the movable seal separates from the seal receiving portion and the first flow path and the second flow path are linked, when a difference of the first pressure relative to the second pressure exceeds a specified pressure, and
the membrane portion is deformed such that the movable seal presses against the seal receiving portion and blocks the link between the first flow path and the second flow path, when the difference is the specified pressure or lower.

19. A membrane valve in accordance with claim 13, wherein
the valve main portion includes a looped seal portion formed on an outer periphery of the valve main portion,
the attachment portion includes:
a first attachment portion affixed to part of an outer periphery of the seal portion, and
a second attachment portion affixed to part of remaining part of the outer periphery of the seal portion, wherein
the first attachment portion and the second attachment portion respectively include the engaging portion.

20. A liquid container that can be installed in a liquid jetting device, comprising:
a liquid storage chamber that stores liquid;
a liquid supply port that supplies the liquid to the liquid jetting device;
a first flow path;
a second flow path; and
a valve that links the first flow path and the second flow path in an open state, and blocks the link between the first flow path and the second flow path in a closed state, wherein
the first flow path or the second flow path is linked to the liquid storage chamber, wherein
the valve includes:
a membrane valve; and
a membrane support portion that supports the membrane valve, wherein
the membrane valve is interposed between the first flow path and the second flow path, wherein
the membrane valve includes:
a valve main portion; and
an attachment portion affixed to the valve main portion, wherein
the valve main portion includes:
a membrane portion that deforms according to a difference between a first pressure in the first flow path and a second pressure in the second flow path; and
a movable portion that is affixed to the membrane portion, and moves according to the deformation of the membrane portion to open and close the valve, wherein
the attachment portion includes N (N is an integer of 2 or greater) engaging portions that engage with the membrane support portion.

21. A liquid container in accordance with claim 20, wherein
the membrane support portion includes N engaging axes that engage with the engaging portion, the engaging portion including an engaging hole in which the engaging axis is inserted, the engaging hole extending along a same direction as a movement direction of the movable portion.

22. A liquid container in accordance with claim 21, wherein
a side surface of the engaging axis contacts at least part of an inner surface of the engaging hole in a state that the engaging axis is inserted in the engaging hole.

23. A liquid container in accordance with claim 21, wherein
an inner diameter of the engaging hole is smaller than or substantially same as an outer diameter of the engaging axis.

24. A liquid container in accordance with claim 20, further including
a coil spring that contacts with the valve main portion and urges the movable portion in a specified direction, and
the valve main portion includes a projecting portion to be inserted in an inside of one end of the coil spring, the projecting portion including a portion of which an outer diameter is substantially same as an inner diameter of the coil spring.

25. A liquid container in accordance with claim 24, wherein
the membrane support portion includes a first concave portion that receives the other end of the coil spring, an inner diameter of the first concave portion being larger than an outer diameter of the coil spring.

26. A liquid container in accordance with claim 20, wherein
the valve main portion includes:
a first surface in the first flow path side; and
a second surface opposite the first surface in the second flow path side, wherein
the liquid container has a seal receiving portion arranged on the first surface side of the valve main portion, and
the movable portion is a movable seal that can contact the seal receiving portion, wherein
the membrane portion deforms such that the movable seal separates from the seal receiving portion and the first flow path and the second flow path are linked, when the difference of the first pressure relative to the second pressure exceeds a specified pressure, and
the membrane portion deforms such that the movable seal is pressed against the seal receiving portion and blocks the link between the first flow path and the second flow path, when the difference is the specified pressure or less.

27. A liquid container in accordance with claim 20, wherein
the valve main portion includes a looped seal portion that forms an outer periphery of the valve main portion,
the attachment portion includes:
a first attachment portion affixed to part of an outer periphery of the seal portion; and
a second attachment portion affixed to part of remaining part of the outer periphery of the seal portion, and
the first attachment portion and the second attachment portion respectively include the engaging portion.

28. A liquid container in accordance with claim 20, including
a second concave portion in which the membrane support portion that supports the membrane valve fits, wherein
the membrane valve is formed in a substantial plate shape,
the membrane support portion is formed in a column shape of which a contour in a cross section parallel to the membrane valve is substantially same as a contour of the membrane valve, in a state that the membrane valve is supported on the membrane support portion, and
the membrane valve is sandwiched between the second concave portion and the membrane support portion.

29. A membrane valve that is interposed between a first flow path and a second flow path, and is used in a valve that links the first flow path and the second flow path in an open state and blocks the link between the first flow path and the second flow path in a closed state, comprising:
a membrane portion that deforms according to a difference between a first pressure in the first flow path and a second pressure in the second flow path; and
a seal portion that is affixed to the membrane portion and is thicker than the membrane portion, wherein
the membrane valve is a valve used in a first state in which the seal portion is sandwiched between a first member and a second member, and
the seal portion includes:
a first seal surface in contact with the first member in the first state; and
a second seal surface in contact with the second member in the first state, wherein
a contact area between the first seal surface and the first member is larger than a contact area between the second seal surface and the second member, and
the membrane portion is affixed at a position in the seal portion that is closer to the first seal surface than the second seal surface between a plane including the first seal surface and a plane including the second seal surface.

30. A membrane valve in accordance with claim 29, further including:
a first surface in the first flow path side;
a second surface opposite the first surface in the second flow path side; and
a movable seal that is affixed to the membrane portion, and moves according to the deformation of the membrane portion to open and close the valve, wherein
the membrane valve is a valve used in a state that a seal receiving portion is arranged at the first surface side of the membrane valve, wherein
the membrane portion deforms such that the movable seal separates from the seal receiving portion and the first flow path and the second flow path are linked, when the difference between the first pressure relative to the second pressure exceeds a specified pressure, and
the membrane portion deforms such that the movable seal presses against the seal receiving portion, and blocks the link between the first flow path and the second flow path, when the difference is the specified pressure or lower.

31. A liquid container that can be installed in a liquid jetting machine, comprising:
a liquid storage chamber that stores liquid;
a liquid supply port that supplies the liquid to the liquid jetting device;
a first flow path;
a second flow path; and
a valve that links the first flow path and the second flow path in an open state, and blocks the link between the first flow path and the second flow path in a closed state, wherein
the first flow path or the second flow path is linked to the liquid storage chamber,
the valve includes a membrane valve interposed between the first flow path and the second flow path, and
the membrane valve includes:
a membrane portion that deforms according to a difference between a first pressure in the first flow path and a second pressure in the second flow path; and
a seal portion that is affixed to the membrane portion, and is thicker than the membrane portion, wherein
the liquid container includes a first member and a second member that, in a first state, sandwich the seal portion,
the seal portion includes: a first seal surface that contacts the first member in the first state; and a second seal surface that contacts the second member in the first state, a contact area of the first seal surface and the first member being larger than a contact area of the second seal surface and the second member, wherein
the membrane portion is affixed at a position in the seal portion that is closer to the first seal surface than the second seal surface between a plane including the first seal surface and a plane including the second seal surface.

32. A liquid container in accordance with claim 31, further including:
a first surface in the first flow path side;
a second surface opposite the first surface in the second flow path side; and
a movable seal that is affixed to the membrane portion, and moves according to the deformation of the membrane portion to open and close the valve, wherein
the liquid container includes a seal receiving portion arranged at the first surface side of the membrane valve, wherein
the membrane portion deforms such that the movable seal separates from the seal receiving portion, and the first flow path and the second flow path are linked, when the difference between the first pressure relative to the second pressure exceeds a specified pressure, and
the membrane portion deforms such that the movable seal presses against the seal receiving portion, and blocks the link between the first flow path and the second flow path, when the difference is the specified pressure or lower.

33. A membrane valve that is interposed between a first flow path and a second flow path, and is used in a valve that links the first flow path and the second flow path in an open state, and blocks the link between the first flow path and the second flow path in a closed state, comprising:
a membrane portion that deforms according to a difference between a first pressure in the first flow path and a second pressure in the second flow path;
a projecting portion that is affixed to the membrane portion, and moves according to the deformation of the membrane portion; and
a first support portion, wherein
in a first case where an end of the projecting portion is faced to a first plane which is a horizontal surface and the membrane valve being placed from vertically upward onto the first plane, an end of the first support portion contacts the first plane and supports the membrane valve, and the end of the projecting portion contacts the first plane in a state that the membrane portion is not deformed.

34. A membrane valve in accordance with claim 33, wherein
the first support portion is formed so as to surround the projecting portion.

35. A membrane valve in accordance with claim 33, further including
a second support portion, wherein
in the first case, an entirety of the membrane portion is placed at a lower position than a second plane defined by a highest portion of the second support portion in a state that the membrane portion is not deformed.

36. A membrane valve in accordance with claim 33, wherein
the membrane valve is formed in a substantial plate shape, and
in a state that the membrane portion is not deformed, a position of the end of the projecting portion, in a thickness direction of the membrane valve, is same as a position of the end of the first support portion in the thickness direction.

37. A membrane valve in accordance with claim 33, further including:
a first surface in the first flow path side;
a second surface opposite the first surface in the second flow path side; and
a movable seal that is affixed to the membrane portion and moves according to the deformation of the membrane portion to open and close the valve, wherein
the membrane valve is a valve used in a state that a seal receiving portion is arranged at the first surface side of the membrane valve, wherein
the membrane portion deforms such that the movable seal separates from the seal receiving portion, and the first flow path and the second flow path are linked, when the difference of the first pressure relative to the second pressure exceeds a specified pressure, and
the membrane portion is deformed such that the movable seal presses against the seal receiving portion and blocks the link between the first flow path and the second flow path, when the difference is the specified pressure or lower.

38. A liquid container that can be installed in a liquid jetting device, comprising:
a liquid storage chamber that stores liquid;
a liquid supply port that supplies the liquid to the liquid jetting device;
a first flow path;
a second flow path; and
a valve that links the first flow path and the second flow path in an open state, and blocks the link between the first flow path and the second flow path in a closed state, wherein
the first flow path or the second flow path is linked to the liquid storage chamber,
the valve includes a membrane valve interposed between the first flow path and the second flow path, and
the membrane valve includes:
a membrane portion that deforms according to a difference between a first pressure in the first flow path and a second pressure in the second flow path;
a projecting portion that is affixed to the membrane portion, and moves according to the deformation of the membrane portion; and
a first support portion, wherein
the membrane valve is configured such that, in a first case where an end of the projecting portion is faced to a first plane which is a horizontal surface and the membrane valve is placed from vertically upward onto the first plane, an end of the first support portion contacts the first plane and supports the membrane valve, and the end of the projecting portion contacts the first plane in a state that the membrane portion is not deformed.

39. A liquid container in accordance with claim 38, wherein
the first support portion is formed so as to surround the projecting portion.

40. A liquid container in accordance with claim 38, wherein
the membrane valve further includes a second support portion, wherein
in the first case, an entirety of the membrane portion is placed at a position lower than a second plane defined by a highest portion of the second support portion in a state that the membrane portion is not deformed.

41. A liquid container in accordance with claim 38, wherein
the membrane valve is formed in a substantial plate shape, and
in a state that the membrane portion is not deformed, a position of the end of the projecting portion, in a thickness direction of the membrane valve, is same as a position of the end of the first support portion in the thickness direction.

42. A liquid container in accordance with claim 38, wherein
the membrane valve further includes:
a first surface in the first flow path side;
a second surface opposite the first surface in the second flow path side; and
a movable seal that is affixed to the membrane portion and moves according to the deformation of the membrane portion to open and close the valve, wherein
the liquid container includes a seal receiving portion that is arranged at the first surface side of the membrane valve, wherein
the membrane portion deforms such that the movable seal separates from the seal receiving portion, and the first flow path and the second flow path are linked, when the difference of the first pressure relative to the second pressure exceeds a specified pressure, and
the membrane portion is deformed such that the movable seal presses against the seal receiving portion and blocks the link between the first flow path and the second flow path, when the difference is the specified pressure or lower.

43. A membrane valve that is arranged at a specified position facing opposite a concave portion, is urged by a coil spring of which one end is in the concave portion and the other end urge the membrane valve, is interposed between a first flow path and a second flow path, and is used in a valve that links the first flow path and the second flow path in an open state, and blocks the link between the first flow path and the second flow path in a closed state, the membrane valve comprising:
a membrane portion that deforms according to a difference between a first pressure of the first flow path and a second pressure of the second flow path; and
a projecting portion inserted in an inside of the other end of the coil spring, wherein
the projecting portion is arranged at a side of a center axis of the coil spring separated from a range of a position at which the projecting portion can contact the other end of the coil spring by moving the coil spring within the concave portion in a direction perpendicular to the center axis of the coil spring.
